(19) United States
(12) Patent Application Publication
(10) Pub. No.: US 2025/0234912 A1
(43) Pub. Date: Jul. 24, 2025

(54) Blend to Eat Food Compositions for Quick Serving

(71) Applicant: Ramaraju Gokaraju, Guntur, Andhra Pradesh (IN)

(72) Inventor: Ramaraju Gokaraju, Guntur, Andhra Pradesh (IN)

(21) Appl. No.: 18/698,806

(22) PCT Filed: Oct. 7, 2022
(86) PCT No.: PCT/IN2022/050897

§ 371 Date: Apr. 5, 2024

(30) Foreign Application Priority Data
Oct. 8, 2021 (IN) 202141045820

(51) Int. Cl. A23L 33/00; A23L 11/00; A23L 13/00; A23L 19/00; A23L 27/10

(52) U.S. Cl. CPC A23L 33/40; A23L 11/01; A23L 13/06; A23L 19/03; A23L 27/11; A23L 27/115

(57) ABSTRACT

The invention provides to blend to eat food composition for a quick serving, which comprises a first component selected from pre-cooked and oil free vegetable(s), pulse(s) and fungi or pre-cooked meat(s) or mixtures thereof; optionally a second component selected from pre-cooked plant derived base or animal derived base; and a third component containing at least one spice/herb/fruit extract derived from spices and/or herbs and/or fruits or mixtures thereof; further containing optionally desired amount of edible oil and salt; for obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually; The present invention further provides the process for preparation of such food compositions and methods of obtaining such functional benefits and methods of obtaining health benefits.

### TECHNICAL FILED

The invention relates to blend to eat food composition for a quick serving, which comprises a first component selected from pre-cooked, dehydrated and oil free vegetable(s), pulse(s) and fungi or pre-cooked meat(s) or mixtures thereof; optionally a second component selected from pre-cooked plant derived base or animal derived base; and a third component containing at least one spice/herb/fruit extract derived from spices and/or herbs and/or fruits or mixtures thereof; further containing optionally desired amount of edible oil and salt; for obtaining at least one functional benefit selected from improving flavour including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually. The present invention further relates to the process for preparation of such food compositions and methods of obtaining such functional benefits and methods of obtaining health benefits.

### Background and Prior Art

With three meals a day, food is an important part of everyone's life. Everybody enjoy eating food that is properly cooked. Preparing food with heat or fire is an activity unique to humans. The origin of cooking can be traced back to ancient times, wherein documented evidence shows that ancient Egyptians used cooking methods such as roasting, broiling, frying and boiling more than 6000 years ago. Cooking has traditionally been a lengthy process carried out informally in home and in many cultures, women used to bear the primary responsibility.

India is a diverse nation with many different cultures and the cuisine differs widely across these cultures. Indian cuisine is still evolving, as a result of the nation's cultural interactions with other societies. Historical incidents such as foreign invasions, trade relations, and colonialism have played a role in introducing certain foods to the country. Indian food is rich in flavor, due to the use of variety of spices. Indian spices have more than 7000 years history. Spices are generously used to create color, savor and flavor to the dishes. With varied climates in different parts of the country, India produces a variety of spices, many of which are native to the subcontinent. India has always been a leading spice consuming, producing and exporting country of the world. Colonialism brought spice trade to India. Many non-native spices were imported during this time from similar climates and cultivated locally. Spices do more than flavor to a dish; they cool and warm the body during hot or cold weather and provide many health benefits. In spite of this rich tradition, Indian food is relatively less appealing to outside world due to the complexity of cooking process and lack of standardization of food and taste.

The consumption of food is more than ever in India today, due to flourishing economy and consequent employment opportunities for the adults. This means less time is available for home cooking. Recent surveys have revealed that time spent on cooking and food preparation has declined substantially in recent years. For a working individuals or busy parents, finding time and energy to prepare home-cooked meals can be a daunting task. After a hectic day at work, ‘eating out’ or ‘ordering in’ seems like the quickest, easiest and convenient option. This created space for many multinational food corporations and their mimicking by Indian food giants to establish businesses in urban areas. They have grown well due to successful standardization of food and tastes. Metropolitan restaurants featuring international cuisines, packaged Indian and foreign foods, indigenous street food and cafés have become very popular. However, the food from restaurants and food outlets is typically high in chemical additives, hormones, sugar, salt, unhealthy fat, and calories, and all of which can adversely affect human health. In addition, they serve food in larger portions and this leads to excessive eating over and above the recommended dietary guidelines. Hence, home cooked food is the only option to address the problems mentioned above. Preparing healthy meals at home can provide control over the ingredients and enable oneself to stick to healthy dietary guidance.

Many new technologies have been introduced to simplify the cooking process for the consumer convenience. Many multinational and domestic companies came out with several pre-cooked, dehydrated and packed food options, so that the consumer can have a ready to eat meal in 5 to 10 minutes. However, they also suffer many inherent disadvantages, such as lack of original flavors, not meeting the individual's taste palate etc.

The PCT application WO/2012/148809 provides food compositions and methods for increasing the palatability of food compositions. In one aspect, the methods comprise adding an egg and chicken flavoring to a food composition. Prior to being added to the food composition, the egg and chicken flavoring can be incorporated in or on any suitable carrier such as, for example, on a soybean, corn or wheat meal carrier. The egg and chicken flavoring has been found to increase the palatability of food compositions over corresponding conventional food compositions that do not include the egg and chicken flavoring.

The patent application 828/MUM/2014 discloses a formulation for blended spices extract containing natural flavor concentrates in liquid form, which can be used as a replacement for traditional spices blend where the composition and concentration of spices are fixed. The spices used in composition are coriander (Dhane), dry coconut (Dry Khobre), unpolished sesame (Til) seeds, cumin (Jire), black cumin (Shahajire), clove (Lavang), black pepper (Kali Miri), white pepper (Safed Miri), cinnamon (Dalchini), large cardamom (Big Veldode), bay leaf (Tamalpatra); mace (Jaipatri), kalpasi (Dagadful), asafetida (Hira Hing), turmeric (Halkund), red chilli (Lai Mirchi), dried ginger (Sunth) and fenugreek seed (Methi Dane).

The US patent application US20070031579A1 describes a formulation and dispensing methodology for liquid spice that can be used as a volume-for-volume replacement for traditional herbs and spices with a flavor true to the fresh herb or spice. This formulation gives a product free of microbiological contamination without the need for chemical or radiation-based disinfection. The formulation comprises a natural-product extraction of fresh or dried herbs or spices, diluted with carriers such as a nutritive oil, ethanol, propylene glycol, or water (or a combination or combinations of the above). The resulting solution can either be used as-such or filtered to provide optimum clarity. The resulting concentration of the flavor component in the carrier is standardized to provide a flavor comparable to a fresh or dried herb or spice.

U.S. patent Ser. No. 10/585,900 disclosed program that directs a computer processor to implement a program that selects at least one substitute ingredient for a food recipe based on a plurality of determined criteria. The program receives a food recipe comprising one or more ingredients, instructions, and preparation time. The program determines time constraints of a user. The program identifies one or more Internet of Things (IoT) enabled cooking devices that are available in a kitchen associated with the user to carry out the instructions of the food recipe. The program searches a market database in a market to identify available options for the at least one substitute ingredient found in the market database based on a similarity level of the at least one substitute ingredient compared with at least one ambiguous ingredient in the food recipe, and selects the at least one substitute ingredient according to the plurality of determined criteria.

However, the above prior art fails to provide a precise cooking process and method for preparing food suitable for individual taste palate with improved taste in quick time with reduced number of steps, reduced oil content and preserved nutritional benefits.

Moreover, there is also a need in the art for better food options with natural ingredients with preserved nutritional and phytochemical benefits, and to simplify the cooking process for wholesome meals and to reduce the cooking time.

Therefore, it is an objective of the present invention to provide safe and palatable food compositions, processes and methods with functional benefits selected from improving taste, improving flavor, reducing oil content, reducing number of cooking steps, reducing preparation time, preparation without tempering step, crafting the dish to personalized taste, flexibility to individually select required levels of nutrients such as carbohydrates, proteins, fats, fiber, macro and micro nutrients.

### SUMMARY OF THE INVENTION

In the light of the above, the present invention provides a blend to eat food composition for a quick serving, which comprises a first component selected from pre-cooked, dehydrated and oil free vegetable(s), fruits, pulse(s) and fungi or pre-cooked meat(s) or mixtures thereof; optionally a second component selected from pre-cooked plant derived base or animal derived base; and a third component containing at least one spice/herb/fruit extract derived from spices and/or herbs and/or fruits or mixtures thereof; further containing optionally desired amount of edible oil and salt; that enables at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually.

According to the invention, the pre-cooked, dehydrated and oil free vegetable(s) is/are selected from but not limited to carrot, beans, squash, eggplant, okra, potato, ivy gourd, ridge gourd, snake gourd, beetroot, bean, bell pepper, bitter gourd, zucchini, corn, pumpkin, green chilli, red chilli, moringa leaves/drumstick, mint, lettuce, cabbage, cauliflower, broccoli, brussels sprouts, fennel leaf, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, apple, pineapple, custard apple, chikoo, guava, pear, papaya or mixtures thereof.

According to the invention, the pre-cooked plant derived base contains one or more of vegetables, pulses, moong dal, toor dal, urad dal, horse gram, fruits, onions, tomatoes, ginger, garlic, nuts, raw mango, tamarind, sugar syrup, jaggery or mixtures thereof; pre-cooked cereals are selected from rice, wheat, sorghum, millet, barley and maize and the like or mixtures there of; coconut grating or milk; and animal derived products selected from but not limited to milk, yogurt, whey protein, yogurt, cream, eggs or mixtures thereof; and the pre-cooked animal base is derived from animal origin selected from but not limited to animal meat and bone stock, animal protein, fat or mixtures thereof.

According to the invention, the third component containing at least one spice/herb/fruit powder or extract is derived from the spice/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seeds, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

In another aspect, the invention provides a process for preparing the blend to eat food compositions with at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually, for quick serving; wherein the food compositions comprise a) a first component selected from pre-cooked, dehydrated and oil free vegetable(s), fruits, pulse(s) and fungi or pre-cooked meat(s) or mixtures thereof; b) optionally a second component selected from pre-cooked plant derived base or animal derived base; c) and a third component containing at least one spice/herb/fruit extract derived from spices and/or herbs and/or fruits or mixtures thereof; further containing optionally desired amount of edible oil and/or salt; wherein the process for the preparation of blend to eat food composition comprises the steps of,
a) Selecting first component from pre-cooked and oil free vegetable(s), pulse(s) and fungi or pre-cooked meat(s) or mixtures thereof;
b) Optionally selecting second component from pre-cooked plant derived base or animal derived base or combinations thereof;
c) Optionally mixing the components selected from steps ‘a’ and ‘b’ to obtain the blend;
d) Rehydrating the blend in step ‘c’ with sufficient hot water to obtain rehydrated blend;
e) Adding a selected third component containing at least one extract derived from spices/herbs/fruits to the rehydrated blend in step ‘d’;
f) Optionally adding the desired amount of salt and edible oil as per individual taste, texture and health; and
g) Mixing the contents of step ‘f’ to obtain the blend to eat food composition.

Yet another objective of the invention is to provide method of obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually; wherein the method comprises preparing a blend to eat food composition having such benefits, which comprises a) a first component selected from pre-cooked, dehydrated and oil free vegetable(s), fruits, pulse(s) and fungi or pre-cooked meat(s) or mixtures thereof; b) optionally a second component selected from pre-cooked plant derived base or animal derived base; c) and a third component containing at least one spice/herb/fruit extract derived from spices and/or herbs and/or fruit or mixtures thereof; further containing optionally desired amount of edible oil and/or salt.

In another aspect, the invention provides method of obtaining at least one health benefit selected from improving satiety, improving healthy weight loss, reducing triglycerides, cholesterol in mammals; wherein the method comprises supplementing the mammals with a blend to eat food composition, which comprises a) a first component selected from pre-cooked and oil free vegetable(s), pulse(s) and fungi or pre-cooked meat(s) or mixtures thereof; b) optionally a second component selected from pre-cooked plant derived base or animal derived base; c) and a third component containing a combination of at least two spice/herb/fruit extracts derived from spices and/or herbs or mixtures thereof; further containing optionally desired amount of edible oil and salt.

### DESCRIPTION OF THE INVENTION

The invention will now be described in detail in connection with certain preferred and optional embodiments so that various aspects thereof may be more fully understood and appreciated.

All the vegetable, spices and other raw materials used in the investigation were procured from the local Farmers Market (Rythu bazars) in Vijayawada, Andhra Pradesh, India.

Unless specified otherwise, all technical and scientific terms used herein have the same meaning as commonly understood by one of ordinary skill in the art to which this invention belongs.

The term “dehydrated” as referred here in the entire specification means and included partially dehydrated or completely dehydrated oil free vegetable(s), fruit(s), pulse(s) and fungi or pre-cooked meat(s) or mixtures thereof.

The dehydrated oil free vegetable(s), fruit(s), pulse(s) and fungi or pre-cooked meat(s) or contains moisture content anywhere in the range of 0 to 30%.

The term “rehydrated” or “rehydrating” as referred herein the entire specification means addition of sufficient water to dehydrated component/blend to obtain rehydrated component/blend.

The terms ‘regular cooking’ and ‘conventional cooking’ as referred herein the entire specification refers to general cooking process. They are interchangeable.

Home cooking is a very complex and time-consuming process. It requires a full-fledged kitchen with cooking station, whole range of cooking vessels, refrigerator, freezer and storage cabinets. Cooking also requires in depth knowledge of cooking techniques, such as boiling, steaming, pressure cooking, roasting, tempering, frying, searing etc.

The broad steps for the standard (conventional) cooking of Indian curries involve, a) Flavor infusion using vegetable oils (Tempering), b) Cooking base veggies in flavor infused oil (sauté or frying), c) Cooking the select meats and veggies (Boiling, simmering and reducing), d) Aroma infusion using ghee or oil (Garnishing). The total cooking including the preparation and lining up of raw ingredients could take anywhere from 45 to 60 min per dish. Standard cooking process requires the use of oil. Prolonged heating in conventional cooking can damage nutritive value and natural phytochemical profile of the raw ingredients. Shelf-life is a limiting factor for conventional home cooked foods. For example, the cooked food stays only good for few hours under room temperature condition and 48 hrs under refrigerated condition. Maintaining the consistency in aroma, taste and texture is also very difficult and it would be difficult to completely satisfy all family members with a given dish, as taste is a subjective property.

In spite of all these adversities, the home cooked food has some good attributes. It is fresh and healthy. However, the homemaker has to spend a few hours a day to cook fresh, healthy and tasty breakfast, lunch and dinner for the family. Unfortunately, the working individuals or busy parents have little time and energy to prepare home-cooked meals. Hence, they generally opt for ‘eating out’ or ‘ordering in’ as a convenient choice. However, the food from restaurants, food outlets and instant foods is typically high in preservatives, emulsifiers, synthetic chemical additives, flavour enhancers, hormones, sugar, salt, unhealthy fat, and calories, and all of which can adversely affect human health.

Hence, the inventor of the current invention conducted many studies with random variation in the cooking process to address the above problems of home cooking and outside foods. He has unexpectedly come up with a novel food preparation concept, which represents a blend to eat (B2E) food composition for a quick serving.

The present invention provides a blend to eat food composition for a quick serving, which comprises a first component selected from pre-cooked, dehydrated and oil free vegetable(s), fruits, pulse(s) and fungi or pre-cooked meat(s) or mixtures thereof; optionally a second component selected from pre-cooked plant derived base or animal derived base or mixtures thereof; and a third component containing at least one spice/herb/fruit extract derived from spices and/or herbs and/or fruits or mixtures thereof; further containing optionally desired amount of edible oil and/or salt.

In an embodiment, all the components of the blend to eat food composition for a quick serving can be provided either as individual packs and then packed all of them in a single retort packing for long term storage.

In an alternative embodiment, all the components of the blend to eat food composition for a quick serving can be provided as individual retort packing for long term storage. The user can blend the selective components of his or her choice to obtain the blend to eat food composition.

The process for producing the said blend to eat (B2E) composition involves adding the pre-cooked, dehydrated and oil free vegetable and pre-cooked plant derived base or animal derived base in to a mixing bowl; adding hot water to the blend to rehydrate the blend; followed by adding spice extract(s) at desired quantity and mixing the contents; and then optionally adding salt and oil as per the individual taste and requirement.

The details process steps for obtaining blend to eat food (B2E) composition according to the invention can be outlined as shown below,
a) Selecting first component from pre-cooked, dehydrated and oil free vegetable(s), pulse (s) and fungi or pre-cooked meat(s) or mixtures thereof;
b) Optionally selecting second component from pre-cooked plant derived base or animal derived base or combinations thereof;
c) Optionally mixing the components selected from steps ‘a’ and ‘b’ to obtain the blend;
d) Rehydrating the blend in step ‘c’ with sufficient hot water to obtain rehydrated blend;
e) Adding a selected third component containing at least one extract derived from spices/herbs/fruits to the rehydrated or rehydration blend in step ‘d’;
f) Optionally adding desired amount of salt and/or edible oil as per individual taste, texture and health;
g) Mixing the contents of step ‘f’ to obtain the blend to eat food composition.

The steps (b) & (c) may be interchanged with step (d) based on the nature of the pre-cooked base. The spice extracts may be added during the rehydration or to the rehydrated of step ‘d’

The pre-cooked vegetable(s) in the above composition is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal toor dal, urad dal, horse gram, adzuki, chana, garbanzo beans, kidney beans, lima beans, mung beans, pinto beans and the like; cereals such as wheat, rice, oats, maize, barley, corn and the like; and the pre-cooked meat is selected from meat group, which comprises chicken, mutton, sea food, cultured or wild aquatic fauna, eggs or mixtures thereof and pre-cooked fruits are selected from the group consisting of banana, mango, chikoo, apple, pineapple, custard apple, guava, pear, papaya or mixtures thereof,

The pre-cooked plant derived base in the said composition contains/derived from one or more of vegetables, pulses, fruits, onions, tomatoes, ginger, garlic, nuts, mango, tamarind, sugar syrup, jaggery or mixture thereof; and animal derived products selected from but not limited to milk, cream, yogurt, whey protein, cream, eggs or mixtures thereof; and the pre-cooked animal base is derived from animal origin selected from but not limited to animal meat and bone stock, animal protein, fat or mixtures thereof,

The third component containing at least one spice/herb/fruit powder or extract for the said composition is derived from the spices/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seeds, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

For example, bottle gourd (sorakaya) curry was produced using the following process steps. The pre-cooked, dehydrated and oil free vegetable blend (96 g) derived from eight cups of fresh, peeled and diced bottle gourd (1500 g) was taken in suitable container. The precooked and dehydrated vegetable base derived from 2 cups of tomato (366 g), 2 cups of diced onion (290 g) and six sliced green chillies (42 g) was added to the pre-cooked dehydrated vegetables and the mixture was rehydrated with hot water to obtain rehydrated blend. Finally, the mixture of rehydrated blend of vegetables and vegetable base was treated with selected combination of spice/herb extracts equivalent to 5.90 g of Jeera (cumin), 32.17 g of fresh garlic, 6.67 g of curry leaves, 13.83 g of red chillies, and 2.50 g of turmeric in required quantity of vegetable oil. Twenty grams of table salt was finally added to the mixture. The contents were gently mixed at ambient temperature to obtain the blend to eat bottle gourd food composition (bottle gourd curry: LFCO001), which is ready to eat with cooked grain or roti.

The unique feature of the current invention is in the simple blending of individual components to obtain the blend to eat food compositions with superior properties (which is not disclosed in the existing art) and the process for the preparation of such compositions (which is 6 to 10 times faster). The inventive features of the invention are further explained below in detail.

New and improved cooking process: The inventive feature of the said composition is its unique process. The process is very simple, no cooking expertise needed and the total preparation time is in the range of 3-8 minutes. The vegetables, fruits, pulses used in the process are pre-cooked, dehydrated and oil free and the plant derived or animal derived base (s) are also pre-cooked, dehydrated and oil free. Unlike the conventional cooking process, the components of blend to eat food composition are not cooked at higher temperature for prolonged periods of time and no tempering step is used. Another unique of the invention is the retention of the original flavor as all aroma and flavor giving phytochemicals remains intact in the current novel blend to eat food composition. The process requires 5-8 times less oil compared to the conventional cooking process, which includes the oil used to deliver the spice extracts. The spice/herb/fruit extracts can be dispensed in required amounts as per the taste of the individual at the end of the cooking process, even after serving the food; in contrast the spice/herb powders or their extracts are added to the whole food during the cooking process in the regular/conventional cooking, restaurant food and instant food. The inventive process does not require any paraphernalia such as a full-fledged kitchen that would otherwise needed for regular home cooking. The only process is effortless blending of the individual components as per the personal taste. This can bypass the steps involved in conventional way of cooking.

Flexibility to adjust nutritional profile: The current inventive process provides flexibility to adjust levels of nutrients such as carbohydrates, proteins, fats, fiber, macro and micro nutrients in the final food composition as per the individual requirement.

The blend to eat food compositions are different and better: The blend to eat food compositions are better than the corresponding food composition produced in the conventional process. It has better retention of phytochemical composition and nutrients; and better organoleptic profile compared to the convention food. They show better original aromas and better taste. Even though the individual components of the blend to eat composition are known, the result is new and the inventive food compositions are better than the equivalent food compositions produced in the conventional process due to the following reasons.

### Better Retention of Natural Phytochemical Compounds of the Vegetables and Spices:

The vegetable blend and other components used in ‘blend to eat composition’ are not subjected to excessive heating and prolonged periods of cooking; and there are no tempering and garnishing steps. Further, as the spice/herb extract blend is added at the final step of the process, the natural phytochemical profile of the spices/herbs and their original flavour (aroma and tsate) remain intact in the final food composition. Hence, the beneficial compounds from vegetables, vegetable bases and spices are well preserved in the blend to eat (B2E) compositions; in comparison they are mostly destroyed in the curry preparations that are produced in regular cooking process. For example, the Carrot Halwa was prepared in conventional and B2E processes. These two recipe samples were subjected similar extraction process using hexane and the extracts concentrated. The extract residues were diluted in equal volume of hexane and analyzed for β-Carotene content. The extracts of conventional and B2E processes showed β-Carotene content of 0.07 g and 0.15 g respectively per 100 g of the extract as per HPLC method of analysis. The B2E version showed 114.3% higher concentration of β-Carotene content over its' conventional version (Example 7). Similarly, the water extracts produced from Beetroot Halwa prepared in conventional and B2E processes showed betanin content of 0.66 g and 1.32 g respectively per 100 g as per HPLC method of analysis. The B2E version thus showed 100% increase in betanin content over the conventional version (Experiment 8). Further, the Tomato and Onion curry produced in B2E process showed 497.33% higher content of Lycopene when compared to the same recipe prepared in conventional cooking process as described in Example 9.

The recipes (Mixed veg curry, Dal amaranthus, Bottle gourd curry, Ridge gourd curry and Vegetable pulav) produced using B2E process also showed superior recovery of spice compounds compared to each of their corresponding recipe versions produced in conventional manner. For example, mixed veg curry was prepared in conventional and B2E processes, keeping the spice extracts either equivalent or less than equivalent in B2E process compared to the quantities of corresponding raw spices used in the conventional process. The weights of conventional and B2E versions for each recipe were made equal for analysis purpose. These two versions were then subjected to similar extraction process using hexane and concentrated. The concentrated extracts were then dissolved in equivalent volume of hexane and analysed for spice compounds using Agilent GC-HS/MS. The compounds were identified based on the molecular weight and comparison with the data in NIST standard reference database. Based on the GC-MS data, the B2E version of mixed veg curry (Example 10) showed peaks for 1,6-octadiene-3-ol-3,7-dimethyl, cinnamaldehyde, eugenol, and trans-isoeugenol with significant peak areas (Table 5), whereas these compounds were not detected in the conventional version of mixed veg curry probably due to extensive degradation during the cooking process. Another prominent compound propanal-2-methyl-3-phenyl was present in both the versions, but the B2E version showed 39.81% higher concentration based on peak area compared to its' conventional counterpart as summarized in Table 5. Similarly, the extract for B2E version of the Dal amaranthus (Example 11) also showed significant peaks in the GC chromatogram for β-pinene, propanal-2-methyl-3-phenyl, 3-caren-10-al or 2-caren-10-al (two peaks). Based on the comparison of the peak areas, these compounds were respectively 345.84%, 870.20%, 1176.8% and 95.46% higher in concentration in B2E version, when compared to their concentrations in conventional version. In addition, the extract of B2E version also showed significant peak corresponding to γ-terpinene, whereas this was not detectable in the extract prepared from conventional version of Dal amaranthus as summarized in Table 6. Similarly, extracts for the B2E versions of Bottle gourd curry (Example 12), Ridge gourd curry (Example 13), and Vegetable pulao (Example 14) also showed significantly higher concentration of the spice compounds compared to their corresponding conventional versions as summarized in Tables 7, 7A and 8 respectively. Notably, the compounds cinnamaldehyde, anethole, eucalyptol, eugenol and trans-isoeugenol showed peaks with significant peak areas in B2E version of Vegetable pulao, whereas none of these compounds were not detected in its conventional version. Overall, the data indicated that the phytochemical compounds undergo extensive degradation during the conventional cooking process, but they are largely protected in B2E cooking process.

### Better Nutritional Profile in B2E Composition Compared to Conventional Cooking:

As the vegetable blend and other components in B2E cooking process are not subjected to excessive heat or long cooking times as in conventional cooking, the blend to eat (B2E) food compositions showed better nutritional profile compared to the equivalent food composition made in conventional process. In addition, the B2E food compositions do not require or require reduced contents of vegetable oil. Hence, they are low in energy and fat content compared to its conventionally cooked food version. As such the B2E food compositions are very healthy. For example, the mixed vegetable curry was prepared in both conventional and Blend to Eat processes as described in Example 15 using the equivalent quantities of vegetables (fresh or cooked and dehydrated), vegetable bases (fresh or cooked and dehydrated) and spices (raw spices or spice extracts) and the samples were analysed for nutritional profiles such as protein, fibers, carbohydrates, fat, energy, calories and vitamins. The observed nutrient values for different parameters were converted into the nutrient values in total weight of the recipe and the results are summarized below in Table 9. The B2E version showed 40.83% and 18.36% higher contents of protein and dietary fibers respectively compared to their corresponding values observed in the conventional version. In addition, the B2E version also showed 21.75% higher carbohydrate content but showed 68.59% reduced fat content, when compared to those in the conventional version. However, none of the vitamins tested were at detectable levels except Vitamin K, wherein the B2E version showed 164.31% higher value compared to that in the conventional version as summarized in Table 9. Similarly, the B2E version of the Vegetable Sambar (Example 16) showed 15.73%, 7.41% and 9.52% better concentrations of protein, dietary fiber and carbohydrates respectively, when compared to their corresponding values in conventional version. On the other hand, the fat content was 60.54% lower in B2E version compared to the corresponding conventional version. The B2E version also showed 18.70% higher vitamin E value over its conventional version. Further, the B2E version also showed 84.61 μg of vitamin K, whereas it is below the detectable limit in the conventional version as summarized in Table 10. The Bottle Gourd curry (Example 17) also showed significantly better concentrations for protein, dietary fiber and total carbohydrate with 107.5%, 19.61% and 26.25% improvements compared to those in its conventional version. However, the B2E version also showed 54.56% and 79.27% reduced values for energy and total fat as summarized in Table 11.

As the vitamins are not observed or found in very low quantities in both B2E and conventional food compositions, the inventors spiked both B2E and conventional versions of different recipes equally with respect to different vitamins to understand their stability and recovery in both the cooking processes. The first vegetable going into the conventional cooking process was spiked in both the versions with the same quantity of each vitamin. The spiked vegetable for the B2E process was then steam cooked and dehydrated along with other vegetables. For example, the Mixed Vegetable curry was prepared in both the conventional and Blend to Eat processes as described in Example 18 using vegetables, bases and spices in case of conventional version and equivalent quantities of cooked and dehydrated vegetables and vegetable bases; equivalent or less than equivalent quantity of spice extracts in case of B2E composition. The fresh onions were spiked with the vitamin E (200 mg), vitamin B12 (10 mg) vitamin A (60 mg) and vitamin D3 (20 mg) in both processes. The finished Mixed Vegetable curry samples from conventional and B2E processes were analysed for nutritional profiles such as protein, fibers, carbohydrates, fat, energy, calories from fat and vitamins. The nutrient values for different nutritional parameters in total weight of the recipe were calculated based on the observed nutrient values per hundred grams of the recipe and the results are summarized in Table 12. The B2E version showed better concentrations for both macro and micro nutrients compared to the corresponding values in convention version. The protein and dietary fiber contents were respectively 38.21% and 10.28% higher in B2E version, when compared to its conventional version, whereas the fat content was reduced by 77.81% over its conventional version. All the spiked vitamins showed better recovery in the B2E version over its conventional version. For example, the B2E version showed 35.24%, 45.63%, 137.01%, 46.49% and 14.84% higher levels of vitamin E, vitamin K (natural), vitamin B12, vitamin A and vitamin D3 respectively as summarized in Table 12.

Similarly, the conventional and B2E versions of Dal palak (Spinach and Toor dal), Carrot and Bottle Gourd sambar, Ridge Gourd curry, Chicken curry, Okra pulusu and Carrot Halwa were prepared by spiking the key vegetable with the vitamins (2.5 mg of Vitamin B12, 5 mg of VitaminD3, 50 mg of Vitamin E and 15 mg of Vitamin A) as in described in Examples 19-24. Their micronutrient and/or macronutrient levels were evaluated and the observed nutrient values for each version were converted into the nutrient values in the total weight of the recipe samples and the results are summarized in Tables 13-18. In all the examples, the B2E version showed better micronutrient (vitamins) values compared to those in the corresponding conventional version. The recipes, for which the macronutrients were measured, showed improved values for protein, dietary fiber and carbohydrates; whereas they showed reduced values for energy and fat content. The foregoing nutritional data clearly shows that B2E food compositions are better and healthy.

Better sensory parameter properties for Blend to Eat food composition: The blend to eat food compositions have shown better scores for sensory parameters than the corresponding conventional versions. For example, the sensory evaluation of the inventive blend to eat food bottle gourd composition (LFCO001; Example 4) was conducted in human volunteers (panellists) in comparison with the similar food recipe sample (LFCO003; Example 6) prepared in a regular/conventional cooking process as described in Example 25. Ten panellists were recruited to the study and randomly assigned to one of the two study groups A or B with five members in each group. All the panellists completed the standard sensory evaluation form following the taste evaluation. The study was done in two phases. The samples of blend to eat food composition were first assigned to group A and the samples from regular cooking process were assigned to group B. The panellists filled out the form rating the appearance, aroma/odour, taste and texture separately using the numerical scores 1 to 9, wherein the criteria for scoring was based on the following assignment of values; like extremely=9, like very much=8, like moderately=7, like slightly=6, neither like nor dislike=5, dislike slightly=4, dislike moderately=3, dislike very much=2 and dislike extremely=1. After the first phase, the groups were crossed over to receive alternate test food sample. The panellists then scored the sensory parameters for the alternate food sample. The scores for each parameter were totaled and the average score was determined. The inventive blend to eat food composition showed average scores of 7.6, 8.8, 8.5 and 7.4 for appearance, aroma/odour, taste and texture respectively, which are significantly better than the respective scores 5.8, 5.3, 6.3 and 5.2 shown by the similar food sample from the regular cooking. The data (Table 19) clearly showed that the inventive blend to eat food composition has the better appearance, aroma, taste and texture than the food preparation from the regular cooking process.

Preparation as per the individual taste: The unique and inventive feature of the said composition is that the spice/herb/fruit extracts can be dispensed in required amounts as per the taste of the individual at the end of the cooking process, even after serving as per the requirement. In contrast, the spice/herb powders or their extracts are added to the whole food during the cooking process in the regular/conventional cooking, restaurant food and instant foods that may or may not suits to the palatability of all the individuals of the family and further may lead to the wastage of the food. As there is a flexibility to adjust relative quantities of the individual components in the inventive ‘blend to eat’ food composition, the curry can be crafted to personalized taste as per the requirement of individual family members and hence reduces wastage of the food.

Significant reduction in the consumption of cooking oil: There is no need to use vegetable oil in B2E cooking process, except a minimal quantity used to deliver the spice extracts or low quantity as per the taste. The cooked dehydrated vegetables or meats and vegetable bases used for the preparation of ‘blend to eat’ food composition can be blended without the use of vegetable oil or with very low quantity compared to conventional cooking. For example, the blend to eat bottle gourd food composition (LFC001) requires the use of only one tea spoon of vegetable oil (4.8 g) for dispensing the spice extracts, whereas the regular bottle gourd curry (LFC003) requires three table spoons (43 g) of the oil during the cooking process. That means consumption of 85% less oil for the preparation of blend to eat compositions compared to the regular cooking. Similarly, the blend to eat food compositions for other recipes also require significantly lower quantity of oil as summarized in the following table for a selected group of recipes (Examples 10 to 14). Hence, the B2E compositions of the present invention are healthy as they provide a low calorie cuisine, when compared to the corresponding food compositions from conventional cooking.

| | | | % Reduction in oil |
|---|---|---|---|
| | Sunflower oil used in grams | | over Conventional |
| Recipe name | Conventional | B2E | process |
| Bottle gourd fry | 21.5 | 5 | 76.74 |
| Dal amaranthus | 20 | 5 | 75.00 |
| Mixed veg | 50 | 15 | 70.00 |
| Ridge gourd curry | 21 | 1 | 95.24 |
| Vegetable pulao | 40 | 10 | 75.00 |
| | 30 (ghee) | 10 (ghee) | 66.67 |

Significant reduction in the consumption of spices: In the regular cooking process, some raw spices are added at the beginning in the tempering step or during the cooking process. Hence, the regular cooking requires higher quantities of spices, as part of the volatile compounds in the spices imparting aroma and taste are lost during the tempering/garnishing steps and further during the cooking process at high temperature. In contrast, the spice/herb extracts or extract blend are added at the final step of the process in blend to eat food composition, which does not involve tempering step or long cooking process. Hence, the compounds in the spices that impart aroma and taste remain intact in the final food composition. As a result, the quantity of spice extract can be significantly reduced from that equivalent to raw spice used in the regular cooking. For example, the spice extract needed for blend to eat food compositions can be reduced up to 35 to 87% compared to the equivalent quantity to raw spice used in the corresponding conventional cooking process. The data for a selected group of recipes (Examples 10 to 14) is summarized in the following table.

| | | | Number | | |
|---|---|---|---|---|---|
| | | Weight of | of drops | Number | % Saving |
| | | raw spice | equiva- | of drops | in spice |
| | | used in | lent | actually | requirement |
| Name of | Name | Conventional | to raw | added | over the |
| the dish | of the | recipe in | spice | in B2E | conventional |
| of ---gms | spice | grams | used | process | process |
| Bottle | Turmeric | 0.62 | 0.86 | 0.25 | 70.78 |
| gourd fry | cumin | 1.47 | 11.46 | 3 | 73.82 |
| | Red chilli | 3.45 | 13.56 | 7 | 48.37 |
| Dal | Turmeric | 1 | 1.38 | 0.5 | 63.77 |
| amaranthus | Cumin | 2 | 15.59 | 2 | 87.17 |
| | Red chilli | 2 | 7.86 | 1 | 87.28 |
| Mixed veg | Garam | 1 | 11.2 | 5 | 55.36 |
| | masala | | | | |
| | coriander | 3 | 17.78 | 12 | 32.52 |
| | red chille | 2.25 | 8.84 | 5 | 43.45 |
| | cumin | 1 | 7.80 | 3 | 61.52 |
| | turmeric | 0.5 | 0.69 | 0.5 | 27.53 |
| Ridge gourd | Turmeric | 0.62 | 0.86 | 0.25 | 70.78 |
| curry | cumin | 1.5 | 11.70 | 3 | 74.35 |
| | red chili | 3.5 | 13.76 | 7 | 49.11 |
| Veg pulao | Garam | 2.5 | 28 | 18 | 35.71 |
| | masala | | | | |
| | Red Chilli | 15 | 58.95 | 6 | 89.82 |

Shorter cooking time compared to regular cooking: Once the precooked, dehydrated and oil free vegetables and precooked bases and spice extracts are available to an ordinary person or consumer, the only process is effortless blending of the individual components as per the personal taste. The total preparation time for blend to eat food composition is in the range of 3-8 minutes, compared to 35 to 50 minutes needed for making a similar dish in regular cooking process. This means significant saving in time and energy from the consumer point of view and the time saved can be invested for other important activities. The cooking times for conventional and B2E cooking processes, and the percentage saving in time over the conventional cooking process for a select group of recipes (Examples 10 to 14) are summarized in the following table. Similar result was obtained for all other recipes described in the examples.

| | Cooking time (minutes) | | % Saving in time over |
|---|---|---|---|
| Recipe name | Conventional | B2E | Conventional process |
| Bottle gourd fry | 35 | 7 | 80.00 |
| Dal amaranthus | 35 | 5 | 85.71 |
| Mixed veg | 40 | 8 | 80.00 |
| Ridge gourd curry | 35 | 7 | 80.00 |
| Veg pulao | 60 | 7 | 80.33 |

No infrastructure requirement: The said inventive process does not require any paraphernalia such as a full-fledged kitchen, electrical appliances etc. that would be otherwise needed for regular home cooking. Glass, porcelain bowls or the disposable containers and spoons are the only kitchen utensils needed for the preparation of inventive blend to eat compositions.

Longer shelf life for individual components: The process for making blend to eat compositions involves only the simple blending of the individual components, which all have longer shelf life. The vegetables and bases are oil free and dehydrated and they were found to have longer shelf life. Similarly, the spice extracts were also found to be very stable at ambient temperature for really longer periods. No rancidity is observed, as the vegetables and bases are cooked without the oil content. Hence, the individual components can be stored up to several months at room temperature; and one year or longer under refrigerated conditions. In comparison, the pre-cooked, dehydrated and packed food can undergo rancidity as they are cooked with vegetable oil.

Health benefits: The inventive blend to eat food compositions exhibited preserved natural phytochemical profiles of the vegetables and spices in addition to minerals and vitamins. In addition, they give the flexibility to adjust the levels of nutrients such as carbohydrates, proteins, fats, fiber, macro and micro nutrients in the final food composition. In addition, the inventive compositions contain no preservatives, emulsifiers, synthetic chemical additives, flavour enhancers, hormones, sugar, salt, unhealthy fat, and calories. Hence, the inventive compositions are healthy.

For example, the efficacy of a novel blend to eat (B2E) diet (BE22001) was evaluated in comparison with a similar diet prepared as per conventional process in improving the health and well-being in healthy adults (Example 26). BE22001 represents the blend to eat food compositions supplemented to the subjects as per the diet schedule during the 60 days study period. Twenty healthy eligible male and female subjects were recruited and randomly assigned into either novel blend to eat diet (BE22001) group or conventional diet group. Consumption of novel blend to eat diet (BE22001) for 60 consecutive days resulted in better reduction of bodyweight (2.35 kg) and BMI (0.91 kg/m²) compared to conventional diet. The blend to eat diet BE22001 showed better improvement in muscle strength and physical activity when compared to conventional diet group as indicated by improved Grip Strength and 6 Minute Walk Test (6MWT). At the end of the study, the BE22001 group showed better reduction of systolic blood pressure, Atherogenic Index Plasma (AIP) and Triglyceride Index (TYG) from the base line indicating that consumption of novel B2E diet for 60 days improves cardiovascular health. Administration of Quality of life questionnaire SF-36 (SF-36QOL) to the study subjects showed better increase in vitality and general health scores in B2E diet (BE22001) compared to conventional diet group. This indicates that consumption of B2E diet improves energy, vigor and general health. Similarly, GSRS and constipation scores were decreased in novel diet BE22001 group to a higher magnitude compared to conventional diet group indicating that consumption of novel B2E diet results in improved digestion and reduced constipation. In addition, the AHSP appetite and daily feelings of hunger scores increased significantly in B2E group compared to conventional diet group indicating reduced appetite and hunger in the novel diet group (B2E). The results of this human study are summarized in Tables 20, 21 and 22.

Overall, consumption of B2E food compositions in a human study showed a number of health benefits, which includes reduction of body weight, improvement in lipid profiles, improved energy, improved digestion, reduced constipation, reduced appetite and hunger, improved cardiovascular health; improved satiety; and improved quality of life, general health and vitality.

Better than pre-cooked and dehydrated branded foods: The pre-cooked and dehydrated meals from food giants such as Triguni, Caprihans, MTR etc. involve re-hydration to obtain ready to eat meals in 10 minutes. However, they are cooked in the convention manner, dehydrated and packed. Their food composition is fixed and their organoleptic properties, such as taste, flavor, aromas etc. cannot be varied and thus may get wasted, if the consumer does not like it. Whereas, the organoleptic properties of the current blend to eat food composition can be varied according to the individual taste palette. The content of salt, nutrients, fat, protein content, fiber and the spices can be varied as per the individual requirement. This is not possible in case of pre-cooked meals. In addition, the pre-cooked and packed meals undergo rancidity, as they are cooked with oil. Hence, the blend to eat compositions of the present invention are better than the pre-cooked and dehydrated meals available in the market, in all aspects, as they provide variable organoleptic properties as per the choice of an individual and thus reduces the wastage of food. They provide food compositions with better taste and nutritional value with reduced amount of calories and thus offer better health benefits.

Long felt and unsolved solution for people with busy life style: Blend to eat compositions offer excellent solution for working individuals or busy parents, who do not find enough time and energy to prepare home-cooked meals after a long day at work or after taking care of household chores. The blend to eat food compositions are also a healthy choice for people, who are on the move and who want to avoid unhealthy food options during travel.

Hence, the current invention can address the gap in the existing art and benefit working professionals, busy mothers, people seeking healthy food options etc.

The present invention can be applicable for any type of recipes, which involve cooking with at least one vegetable and at least one spice item. For example, preparation of blend to eat ridge gourd curry (iguru) food composition, blend to eat Sambar food composition, blend to eat toor dal food composition, blend to eat bottle gourd pulusu food composition, blend to eat carrot Halwa sweet food composition, blend to eat Vendakaiya Perugu Thalimpu, blend to eat cream of beetroot soup food composition, blend to eat Home style Mutton Kheema Masala food composition, blend to eat Mixed vegetable curry, Dal amaranthus curry, vegetable pulav, blend to eat Home Style Chicken Curry food composition and other recipes was demonstrated using the similar process described above.

Overall, the said blend to eat food composition showed many functional benefits, which include but not limited to improving flavors including taste and aroma, reducing oil content, optionally reducing salt content, promoting healthy weight loss, reducing number of cooking steps, reducing preparation time, eliminating tempering step, crafting the dish to personalized taste, selecting and optimizing individually the required levels of nutrients such as carbohydrates, proteins, fats, fiber, macro and micro nutrients.

Hence, in an important embodiment the invention provides a blend to eat food composition for a quick serving, which comprises a first component selected from pre-cooked, dehydrated and oil free vegetable(s), fruits, pulse(s) and fungi or pre-cooked meat(s) or mixtures thereof; optionally a second component selected from pre-cooked plant derived base or animal derived base; and a third component containing at least one spice/herb/fruit extract derived from spices and/or herbs and/or fruits or mixtures thereof; further containing optionally desired amount of edible oil and/or salt; for obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually.

In other important embodiment the invention provides an ingredient kit for blend to eat food composition for a quick serving, which comprises a first component selected from pre-cooked, dehydrated and oil free vegetable(s), fruits, pulse(s) and fungi or pre-cooked meat(s) or mixtures thereof; optionally a second component selected from pre-cooked plant derived base or animal derived base; and a third component containing at least one spice/herb/fruit extract derived from spices and/or herbs and/or fruits or mixtures thereof; further containing optionally desired amount of edible oil and/or salt; for obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually.

In another important embodiment the invention provides a blend to eat food composition for a quick serving, which comprises a first component selected from pre-cooked, dehydrated and oil free vegetable(s), fruits, pulse(s) and fungi or pre-cooked meat(s) or mixtures thereof; optionally a second component selected from pre-cooked plant derived base or animal derived base; and a third component containing at least one spice/herb/fruit extract derived from spices and/or herbs and/or fruits or mixtures thereof; further containing optionally desired amount of edible oil and/or salt; for obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually, Wherein the said blend to eat food composition is obtained by the steps of,
a) Selecting a first component from pre-cooked, dehydrated and oil free vegetable(s), pulse(s) and fungi or pre-cooked meat(s) or mixtures thereof;
b) Optionally selecting a second component from pre-cooked plant derived base or animal derived base or combinations thereof;
c) Optionally mixing the components selected from steps ‘a’ and ‘b’ to obtain the blend;
d) Rehydrating the blend in step ‘c’ with sufficient hot water to obtain rehydrated blend;
e) Adding a selected third component containing at least one extract derived from spices/herbs/fruits to the rehydrated or rehydrating blend in step ‘d’;
f) Optionally adding desired amount of salt and/or edible oil as per individual taste, texture and health;
g) Mixing the contents of step ‘f’ to obtain the blend to eat food composition,

The pre-cooked vegetable(s) is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, chikoo, guava, pear, papaya or mixtures thereof,

The pre-cooked plant derived base contains one or more of vegetables, pulses, lentils, moong dal, toor dal, urad dal, horse gram, fruits, onions, tomatoes, ginger, garlic, nuts, mango, tamarind, sugar syrup, jaggery or mixture thereof; pre-cooked cereals are selected from rice, wheat, sorghum, millet, barley and maize and the like or mixtures there of; coconut grating or milk; and animal derived products are selected from but not limited to milk, yogurt, whey protein, cream, eggs or mixtures thereof; and the pre-cooked animal base is derived from animal origin selected from but not limited to animal meat and bone stock, animal protein, fat or mixtures thereof.

The third component containing at least one spice/herb/fruit powder or extract is derived from the spices/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seeds, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

In the other important embodiment the invention provides process for preparing the blend to eat food compositions with at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually, for quick serving; wherein the food compositions comprise a first component selected from pre-cooked, dehydrated and oil free vegetable(s), pulse(s) and fungi or pre-cooked meat(s) or mixtures thereof; optionally a second component selected from pre-cooked plant derived base or animal derived base; and a third component containing at least one spice/herb/fruit extract derived from spices and/or herbs and/or fruits or mixtures thereof; further containing optionally desired amounts of edible oil and salt; which comprises the steps of,
a) Selecting first a component from pre-cooked, dehydrated and oil free vegetable(s), pulse(s) and fungi or pre-cooked meat(s) or mixtures thereof;
b) Optionally selecting a second component from pre-cooked plant derived base or animal derived base or combinations thereof;
c) Optionally mixing the components selected from steps ‘a’ and ‘b’ to obtain the blend;
d) Rehydrating the blend in step ‘c’ with sufficient hot water to obtain rehydrated blend;
e) Adding a selected third component containing at least one extract derived from spices/herbs/fruits to the rehydrated or rehydrating blend in step ‘d’;
f) Optionally adding desired amount of salt and/or edible oil as per individual taste, texture and health;
g) Mixing the contents of step ‘f’ to obtain the blend to eat food composition

The pre-cooked vegetable(s) according the process of the present invention is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, pineapple, apple, custard apple, chikoo, guava, pear, papaya or mixtures thereof.

The pre-cooked plant derived base according the process of the present invention contains one or more of vegetables, pulses, lentils, moong dal, toor dal, urad dal, horse gram, fruits onions, tomatoes, ginger, garlic, nuts, mango, tamarind, sugar syrup, jaggery or mixtures thereof; pre-cooked cereals are selected from rice, wheat, sorghum, millet, barley and maize and the like or mixtures there of; coconut grating or milk; and animal derived products selected from but not limited to milk, yogurt, whey protein, cream, eggs or mixtures thereof; and the pre-cooked animal base is derived from animal origin selected from but not limited to animal meat and bone stock, animal protein, fat or mixtures thereof, The third component containing at least one spice/herb/fruit powder or extract according the process of the present invention is derived from the spices/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seed, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

In a further embodiment the invention provides methods of obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually; wherein the method comprises preparing a blend to eat food composition having such benefits, which consists the steps of;
a) Selecting first component from pre-cooked, dehydrated and oil free vegetable(s), pulse(s) and fungi or pre-cooked meat(s) or mixtures thereof;
b) Optionally selecting second component from pre-cooked plant derived base or animal derived base or combinations thereof;
c) Optionally mixing the components selected from steps ‘a’ and ‘b’ to obtain the blend;
d) Rehydrating the blend in step ‘c’ with sufficient hot water to obtain rehydrated blend;
e) Adding a selected third component containing at least one extract derived from spices/herbs/fruits to the rehydrated or rehydrating blend in step ‘d’;
f) Optionally adding desired amount of salt and/or edible oil as per individual taste, texture and health;
g) Mixing the contents of step ‘f’ to obtain the blend to eat food composition,

The pre-cooked, dehydrated vegetable(s) to obtain such functional benefits may be selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, apple, pineapple, custard apple, chikoo, guava, pear, papaya or mixtures thereof.

The pre-cooked plant derived base to obtain such functional benefits may contains one or more of vegetables, pulses, lentils, moong dal, toor dal, urad dal, horse gram, fruits, onions, tomatoes, ginger, garlic, nuts, mango, tamarind, sugar syrup, jaggery or mixtures thereof; pre-cooked cereals are selected from rice, wheat, sorghum, millet, barley and maize and the like or mixtures there of; coconut grating or milk; and animal derived products selected from but not limited to, milk, yogurt, whey protein, cream, eggs or mixtures thereof; and the pre-cooked animal base is derived from animal origin selected from but not limited to animal meat and bone stock, animal protein, fat or mixtures thereof.

The third component containing at least one spice/herb/fruit powder or extract to obtain such functional benefits are derived from the spices/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seed, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind, Thyme, Turmeric rhizome and mixtures thereof.

In a further embodiment, the invention provides method of obtaining at least one health benefit selected from improving healthy weight loss, reducing body weight, reducing triglycerides and cholesterol, increasing healthy cholesterol, improving energy, improving digestion, reducing constipation, reducing appetite and hunger, improving satiety, improving cardiovascular health and improving quality of life, improving vigor and improving general health in mammals; wherein the method comprises supplementing the mammals with a blend to eat food composition, which comprises a) a first component selected from pre-cooked, dehydrated and oil free vegetable(s), pulse(s) and fungi or pre-cooked meat(s) or mixtures thereof; b) optionally a second component selected from pre-cooked plant derived base or animal derived base; c) and a third component containing at least one spice/herb/fruit extract derived from spices and/or herbs and/or fruits or mixtures thereof; further containing optionally desired amount of edible oil and/or salt; wherein the process for preparing the blend to eat food composition comprises the steps of; a) selecting first component from pre-cooked, dehydrated and oil free vegetable(s), pulse(s) and fungi or pre-cooked meat(s) or mixtures thereof; b) optionally selecting second component from pre-cooked plant derived base or animal derived base or combinations thereof; c) optionally mixing the components selected from steps ‘a’ and ‘b’ to obtain the blend; d) rehydrating the blend in step ‘c’ with sufficient hot water to obtain rehydrated blend; e) adding a selected third component containing at least one extract derived from spices/herbs/fruits to the rehydrated blend in step ‘d’; f) optionally adding desired amount of salt and/or edible oil as per individual taste, texture and health; g) mixing the contents of step ‘f’ to obtain the blend to eat food composition;

Wherein the pre-cooked vegetable(s) is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof; and pre-cooked fruits are selected from the group consisting of banana, mango, chikoo, guava, pear, papaya or mixtures thereof,

Wherein the pre-cooked, plant derived base contains one or more of vegetables, pulses, lentils, moong dal, toor dal, urad dal, horse gram, fruits, onions, tomatoes, ginger, garlic, nuts, mango, tamarind, sugar syrup, jaggery or mixtures thereof; and animal derived products selected from but not limited to milk, yogurt, soya protein isolate, whey protein, cream, eggs or mixtures thereof; pre-cooked cereals are selected from rice, wheat, sorghum, millet, barley and maize and the like or mixtures there of; coconut grating or milk; and the pre-cooked animal base is derived from animal origin selected from but not limited to animal meat and bone stock, animal protein, animal fat or mixtures thereof, Wherein the third component containing at least one spice/herb/fruit powder or extract is derived from the spice/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dil, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind, fruit, Thyme, Turmeric rhizome and mixtures thereof.

In an additional embodiment, the invention provides a process for reducing/simplifying the number of steps for the preparation of a blend to eat food composition having at least one functional benefit selected from improving taste, improving flavor, reducing oil content, reducing number of steps, reducing preparation time, avoiding tempering step, crafting the dish to personalized taste; where in the process comprises the steps of,
a) Selecting first component from pre-cooked, dehydrated and oil free vegetable(s), pulse(s) and fungi or pre-cooked meat(s) or mixtures thereof;
b) Optionally selecting second component from pre-cooked plant derived base or animal derived base or combinations thereof;
c) Optionally mixing the components selected from steps ‘a’ and ‘b’ to obtain the blend;
d) Rehydrating the blend in step ‘c’ with sufficient hot water to obtain rehydrated blend;
e) Adding a selected third component containing at least one extract derived from spices/herbs/fruits to the rehydrated blend in step ‘d’;
f) Optionally adding desired amount of salt and/or edible oil as per individual taste, texture and health;
g) Mixing the contents of step ‘f’ to obtain the blend to eat food composition,

The pre-cooked, dehydrated vegetable(s) is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, chikoo, guava, pear, papaya or mixtures thereof. The pre-cooked plant derived base contains one or more of vegetables, pulses, lentils, moong dal, toor dal, urad dal, horse gram, fruits, onions, tomatoes, ginger, garlic, nuts, mango, tamarind, sugar syrup, jaggery or mixtures thereof; pre-cooked cereals are selected from rice, wheat, sorghum, millet, barley and maize and the like or mixtures there of; coconut grating or milk; and animal derived products selected from but not limited to, milk, yogurt, whey protein, cream, eggs or mixtures thereof; and the pre-cooked animal base is derived from animal origin selected from but not limited to animal meat and bone stock, animal protein, fat or mixtures thereof.

The third component containing at least one spice/herb/fruit powder or extract is derived from the spice/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seeds, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

In other embodiment of the invention, the spices/herb/fruits extracts are obtained by extraction of the pulverized raw material of spices/herb/fruits with at least one solvent with the polarity index (P) in the range of 0.05 to 10.2, which are selected from C1-C5 alcohols selected from ethanol, methanol, n-propanol, isopropyl alcohol; ketones selected from acetone, methyl isobutyl ketone, chlorinated solvents selected from methylene dichloride and chloroform; water and mixtures thereof; C1-C7 hydrocarbons such as hexane; esters like ethyl acetate and the like and mixtures thereof.

In another embodiment of the invention, the spice/herb/fruit extracts are obtained by steam distillation of pulverized spice/herb/fruit raw material to obtain the essential oil (EO) first; then the raw material residue is extracted either sequentially or selectively with at least one solvent selected from C1-C5 alcohols selected from ethanol, methanol, n-propanol, isopropyl alcohol; ketones selected from acetone, methyl isobutyl ketone, chlorinated solvents selected from methylene dichloride and chloroform; water and mixtures thereof; C1-C7 hydrocarbons such as hexane; esters like ethyl acetate and the like and mixtures thereof; the essential oil can be used to make blend to eat food compositions, or the selected extract(s) or selected extract(s) and the essential oil corresponding to each raw material can be combined in desired ratio to obtain the final extract/oleoresin/combination with required aroma and flavor; in a further variation of the process, the essential oil (EO) and the extract(s) can be obtained from separate lots of the selected spice/herb/fruit raw material and then the EO and extract(s) can be combined with the extract of the same material at desired ratio to obtain the final extract/oleoresin/combination with required aroma and taste.

In another embodiment of the invention, the commercially available oleoresins can also be used; further, the spice/herb/fruit essential oil, extracts and/or oleoresins or the mixtures thereof can be diluted in vegetable oil to facilitate dispensing as per the requirement. Natural identical flavors and aromas, coloring agents and food additives, taste enhancers can also be used along with the spice/herb/fruit extracts. In one other embodiment of the invention, the cooked vegetables are dehydrated using one of the drying techniques selected from but not limited to freeze drying, vacuum drying, hot air oven drying, infrared/radiofrequency/microwave drying (with or without vacuum) or combinations thereof; alternately, the stock liquid and vegetables are separated from the cooked vegetables; the vegetables part dehydrated using the drying techniques disclosed above; and the stock liquid part can be dried using freeze dryer or spray drying or vacuum distillation; or it can be first concentrated under vacuum at slightly elevated temperature to partially remove water and then the final dehydration can be done using freeze drying or spray drying to obtain the juice stock powder; and finally, the juice stock powder and dehydrated vegetables can be combined and blended to obtain pre-cooked and dehydrated vegetables.

In yet another embodiment of the invention, the pre-cooked plant derived base is produced from one or more of vegetables, pulses, fruits, onions, tomatoes, ginger, garlic, nuts, mango, tamarind, sugar, jaggery, and animal derived products selected from but not limited to milk, whey protein, cream, eggs or mixtures thereof; and the pre-cooked animal base is derived from animal origin selected from but not limited to animal meat and bone stock, animal protein, fat or mixtures thereof; wherein the said the bases are prepared with or without the use of vegetable oil; the said base can be used in paste form packed in protective packing; alternately, the cooked vegetable base or the animal base can be dehydrated or partially dehydrated using any of the techniques selected from but not limited to freeze drying, spray drying, vacuum drying, hot air oven drying, infrared/radiofrequency/microwave drying (with or without vacuum) or combinations thereof to obtain the pre-cooked vegetable base or pre-cooked animal base in a thick paste or powder form and the said paste, thick paste or powder form can be used to produce the novel blend to eat food compositions.

In another embodiment of the invention, the food item for making the blend to eat food composition can be selected from but not limited to iguru curries, pulusu curries, dal curries, fry curries, dry roast curries, chutneys, soups, lentil soups, vegetable soups, animal derived soups, sweet recipes, and recipes containing rice, which are selected from regional Indian cuisines (South, Central, North, East and West Indian cuisines) and International cuisines.

In one embodiment, the pre-cooked, dehydrated and oil free vegetable(s), pre-cooked and oil free vegetable(s), pre-cooked the plant derived base(s), pre-cooked animal derived base(s), the pre-cooked plant derived bases without dehydration or partial dehydration, pre-cooked animal derived base(s) without dehydration or with partial dehydration can be packed in retort packing for long term storage. The retort packing can be selected from but not limited to packing materials made from a laminate of flexible plastic or metal foils, metal-plastic laminate and multi-layered structures or combinations thereof.

### EXAMPLES

### Example 1: Procedure for Preparation of Pre-Cooked, Dehydrated and Oil Free Vegetable(s)

1A: Eight cups of fresh peeled and diced bottle gourd (1500 g) pieces and water (100 ml)were taken in pressure cooker pan. The lid was closed and pressure cooked the contents until the first whistle. The pressure was released and the contents transferred to a freeze drying vessel. The cooked vegetables along with stock liquid were freeze dried until the moisture is completely removed to obtain the pre-cooked, dehydrated and oil free vegetables (96 g).

1B: Preparation of dehydrated ridge gourd curry vegetable: A cleaned ridge gourd was peeled and processed into small pieces. Separately, properly washed tomatoes were cut into small pieces. Nine cups of ridge gourd pieces (1400 g) and 2 cups of cut tomato pieces (366 g) in minimum amount of water were cooked in pressure cooker for one whistle. The contents were transferred to a glass jar, frozen and freeze dried until the moisture was completely removed to obtain pre-cooked, dehydrated and oil free ridge gourd vegetable (90 g).

Other pre-cooked vegetable(s) were produced by adopting similar or different cooking procedure. The details of the vegetables, cooking process and the results are summarized below in table 1.

TABLE 1
Details for preparation of dehydrated, oil free vegetables

| | | | Weight of |
|---|---|---|---|
| Expt. | | | dehydrated |
| No | Vegetable | Cooking time | Vegetable |
| 1C | Two and half cups of | One whistle on | 40.0 g |
| | sorakaya pieces (500 g), ⅔ | pressure cooker | |
| | cup diced onion, four diced | | |
| | green chillies | | |
| 1D | Ridge gourd (250 g), | One whistle on | 14.9 g |
| | tomato (50 g) | pressure cooker | |
| 1E | Brinjal (250 g), | One whistle on | 20.5 g |
| | tomato (50 g) | pressure cooker | |
| 1F | Cluster beans without the | Two whistles on | 34.5 g |
| | head and tails (250 g) + | pressure cooker | |
| | 50 mL water | | |

1G: Preparation of pre-cooked, dehydrated and oil free vegetables for making blend to eat sambar food composition: The one medium size onion was peeled and diced. Two drumsticks were cut in to two inch pieces. Four okra were cut into one inch pieces after removing the head and the tail parts. One medium size carrot was diced in to circular pieces. One large tomato was diced into small pieces. All the above vegetables along with two sliced green chillies and one cup of water were cooked for two whistles on a pressure cooker. The pressure was released and the contents were transferred to a freeze drying vessel. The cooked vegetables along with stock liquid were freeze dried until the moisture is completely removed to obtain the pre-cooked, dehydrated and oil free vegetables for making blend to eat sambar food composition.

1H: Preparation of pre-cooked, dehydrated and oil free toor dal: One cup of toor dal was soaked in room temperature water for 15-20 minutes. Water was drained from the dal and transferred it to pressure cooker pan. Two sliced green chillies and 2 cups of water were added to the dal. The lid was closed and pressure cooked the contents for two whistles. The pressure was released and the contents transferred to a freeze drying vessel. The contents were freeze dried until the moisture is completely removed to obtain the pre-cooked, dehydrated and oil free toor dal.

In a variation of the experiment, the cooking can be done using any of the cooking vessels selected from but not limited to standard cooking vessel with lid, electric cooker, electric pot pressure cooker. In a further variation of the experiment to reduce the overall drying time, the cooked vegetables were first subjected to vacuum drying using high vacuum and temperature around 50° C. to remove up to 60% of the moisture. Then, further drying of the vegetables was continued on freeze dryer. In an alternate procedure, following the pressure cooking, the stock liquid was separated from cooked vegetables using a strainer. The stock liquid was concentrated under vacuum at around 50° C. on a rotary evaporator to evaporate 60-70% water and then subjected to freeze drying or spray drying to obtain stock powder. The vegetables were freeze dried separately to obtain de-hydrated vegetables. Finally, the stock powder and dehydrated vegetables were combined and blended to obtain pre-cooked and dehydrated vegetables.

### Example 2: Preparation Pre-Cooked Vegetable Bases

2A: Preparation of precooked and concentrated vegetable base—onion and tomato base: Two tea spoons of oil was added to a pressure cooker pan and allowed the oil to become hot. Two cups of diced onion (290 g) were added to the pan and cooked for 10-15 minutes until they were sautéed and become translucent. Then added two cups of tomato pieces (366 g) and six sliced green chillies (42 g) to the pan, stirred well, closed the lid and continued the cooking for 15 to 20 minutes. The contents were allowed to cool and ground the mixture to a smooth paste to obtain the pre-cooked vegetable base. Alternatively, the said vegetable base was subjected to vacuum drying or freeze drying to obtain vegetable base in powder form.

In a variation of the above procedure, the base was prepared without the use of vegetable oil. In a further variation, the onion and tomato base was prepared along with garlic and ginger, wherein the garlic paste and ginger paste were added to the pan after the onion pieces were translucent.

2B: Preparation of precooked lentil (toor dal) base: Add one cup of toor dal and one and half cup of water into pressure cooker pan. Close the lid along with the pressure regulator and the contents were pressure cooked on a medium flame for 4 whistles. The pressure was released and the water content was reduced by evaporation on low flame. The cooked dal was mashed to obtain the pre-cooked dal lentil (toor dal) base in paste form. The paste was subjected to vacuum drying to obtain the pre-cooked dal lentil (toor dal) base in a powder form.

2C: Preparation of Tamarind and Jaggery base: De-seeded tamarind (40 g) was soaked in 300 mL water in a heating bowl. The mixture was cooked to boiling and mashed jaggery (40 g) was added to the mixture and the heating continued for 5 minutes. The mixture was filtered and the solution was dehydrated under vacuum to obtain the cooked tamarind and jaggery base.

2D: Preparation of precooked and concentrated vegetable base—onion base: One tea spoon of oil was added to a pressure cooker pan and allowed the oil to become hot. Two cups of diced onion (290 g) were added to the pan and cooked for 10-15 minutes until they were sautéed and become translucent. The contents were allowed to cool and ground the mixture to a smooth paste to obtain the pre-cooked (onion) vegetable base.

In other variation, the vegetable base can be dehydrated on freeze dryer or vacuum dryer or using any of the drying techniques to obtain the vegetable base in a powder form.

Commercially available vegetable bases or meat derived can also be used.

The vegetable bases or meat bases without the dehydration or with partial dehydration can be also be used, which can be secured in retort packing for long term storage.

### Example 3: Process for the Preparation of Spice Extracts

Typically, the spice/herb/fruit raw material was pulverized and loaded into a round bottomed flask equipped with stirrer and reflux condenser. Hexane (2.5 L) was added to the raw material and the contents were stirred at reflux temperature for 2 hours. The extract was separated and the spent raw material was re-extracted two more times with hexane (2.OL). The extracts were combined and filtered through celite bed. The solvent was evaporated at ambient temperature under reduced pressure. The concentrated extract was kept under high vacuum for 30 minutes to remove hexane residue. The concentrated extract was transferred into a small glass container for storage. The spice/herb/fruit raw materials, Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seed, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme and Turmeric rhizome, were extracted using the said typical process disclosed above and the results are summarized below in table 2.

Ethyl acetate and acetone extracts of selected spice raw materials were prepared using the same extraction process disclosed above for hexane extracts and the results are summarized in tables 3 and 4.

TABLE 2
Summary of hexane extraction of herbs and spices

| S. No | Spice/Herb name | Weight of RM | Weight of extract | |
|---|---|---|---|---|
| 1 | Amchoor | 500.0 g | 2.0 | g |
| 2 | Asafoetida | 500.0 g | 8.40 | g |
| 3 | Basil leaf | 500.0 g | 11.40 | g |
| 4 | Bay leaf | 500.0 g | 9.90 | g |
| 5 | Capsicum | 500.0 g | 0.70 | g |
| 6 | Caraway seed | 500.0 g | 24.40 | g |
| 7 | Cardamom green | 500.0 g | 31.10 | g |
| 8 | Cardamom black | 500.0 g | 12.60 | g |
| 9 | Cinnamon | 500.0 g | 29.00 | g |
| 10 | Celery seeds | 500.0 g | 28.70 | g |
| 11 | Chives | 500.0 g | 1.90 | g |
| 12 | Clove | 500.0 g | 93.00 | g |
| 13 | Coriander leaf | 500.0 g | 0.700 | g |
| 14 | Coriander seed | 500.0 g | 44.00 | g |
| 15 | Cumin black | 500.0 g | 124.00 | g |
| 16 | Cumin brown | 500.0 g | 68.00 | g |
| 17 | Curry leaf | 500.0 g | 5.300 | g |
| 18 | Dill (Suva) | 500.0 g | 23.10 | g |
| 19 | Fennel | 500.0 g | 25.10 | g |
| 20 | Fenugreek leaf | 500.0 g | 15.70 | g |
| 21 | Fenugreek seed | 500.0 g | 12.00 | g |
| 22 | Garlic | 500.0 g | 1.200 | g |
| 23 | Ginger | 500.0 g | 1.900 | g |
| 24 | Green chilli | 500.0 g | 0.600 | g |
| 25 | Kapok buds | 500.0 g | 1.500 | g |
| 26 | Mace | 500.0 g | 75.10 | g |
| 27 | Mint leaf | 500.0 g | 1.50 | g |
| 28 | Mustard seed | 500.0 g | 149.00 | g |
| 29 | Nutmeg | 500.0 g | 145.50 | g |
| 30 | Onion | 500.0 g | 0.15 | g |
| 31 | Onion Fried | 500.0 g | 201.2 | g |
| 32 | Oregano | 500.0 g | 15.10 | g |
| 33 | Parsley leaf | 500.0 g | 10.00 | g |
| 34 | Pepper black | 500.0 g | 16.10 | g |
| 35 | Pepper white | 500.0 g | 18.50 | g |
| 36 | Poppy seed | 500.0 g | 203.80 | g |
| 37 | Red chilli dry | 500.0 g | 29.50 | g |
| 38 | Rosemary leaf | 500.0 g | 20.80 | g |
| 39 | Shallots | 500.0 g | 0.80 | g |
| 40 | Star anise | 500.0 g | 38.00 | g |
| 41 | Tamarind fruit | 500.0 g | 0.25 | g |
| 42 | Thyme | 500.0 g | 16.0 | g |
| 43 | Turmeric rhizome | 500.0 g | 13.80 | g |

TABLE 3
Details of Ethyl Acetate Extracts

| | | Details of the ethyl acetate | | |
|---|---|---|---|---|
| | | extracts | | |
| SN | Name of the spice raw material | Qty. of RM | Qty. of Extract | |
| 1 | Avalu | 500.0 g | 157.0 | g |
| 2 | Bengal Dal | 500.0 g | 22.10 | g |
| 3 | Cashew | 500.0 g | 216.2 | g |
| 4 | Coriander Leaves | 500.0 g | 5.50 | g |
| 5 | Crushed Garlic pods | 500.0 g | 1.80 | g |
| 6 | Curry Leaves (Fresh Leaf) | 500.0 g | 13.0 | g |
| 7 | Dhaniya | 500.0 g | 33.00 | g |
| 8 | Dry Red Chillies | 500.0 g | 31.00 | g |
| 9 | Hing (Asafoetida) | 500.0 g | 12.0 | g |
| 10 | Jeera | 500.0 g | 101.0 | g |
| 11 | Minced Garlic (paste) | 500.0 g | 2.80 | g |
| 12 | Minced Ginger (paste) | 500.0 g | 6.0 | g |
| 13 | Minced Green Chilli (paste) | 500.0 g | 1.80 | g |
| 14 | Onions paste | 500.0 g | 0.90 | g |
| 15 | Red Chilli Powder | 500.0 g | 73.80 | g |
| 16 | Slit Green Chillies (small pieces) | 500.0 g | 1.20 | g |
| 17 | Small Diced Onions | 500.0 g | 0.3 | g |
| 18 | Tamarind fruit | 500.0 g | 14.50 | g |
| 19 | Turmeric rhizome | 500.0 g | 38.10 | g |

TABLE 4
Details of Acetone Extracts

Details of acetone extracts

| S. | Name of the spice | | Qty. of Acetone |
|---|---|---|---|
| No | raw material | Qty. of RM | extract |
| 1 | Coriander Leaves | 400.0 g | 11.0 g |
| 2 | Curry Leaves | 500.0 g | 27.0 g |
| 3 | Green Chilli (Minced) | 500.0 g | 19.3 g |
| 4 | Onions paste | 500.0 g | 48.0 g |
| 5 | Garlic paste | 500.0 g | 8.50 g |
| 6 | Ginger paste | 500.0 g | 13.0 g |
| 7 | Hing (Asafoetida) | 500.0 g | 16.0 g |

In a variation of this process, the raw material was subjected to steam distillation to obtain the essential oil (EO) in the first step. The raw material residue was then extracted with hexane and/or other solvents selected from ethyl acetate, acetone, ethanol etc. The extract(s) were combined with the essential oils to obtain required aroma and flavor as per the requirement.

Alternately, the commercially available essential oils, extracts and oleoresins can also be used.

Optionally, the essential oil/extracts/oleoresin derived from spices/herbs/fruits were diluted in vegetable oil to facilitate dispensing as per the requirement.

In a further variation, natural identical flavors and aromas, coloring agents and food additives, taste enhancers can be used along with the spice/herb/fruit extracts.

The yields of the spice/fruit extracts vary batch to batch based on the raw material source, geographic location, maturity etc. Hence, the spice extract equivalency to the raw spice material can be considered based on the yield of the specific batch from which the spice extract is used for recipe preparation.

### Example 4: Preparation of Blend to Eat Bottle Gourd Food Composition (Bottle Gourd Curry; LFC001)

Bottle gourd (sorakaya) curry was produced using the following process steps. The pre-cooked, dehydrated and oil free vegetables (Experiment 1A), pre-cooked vegetable base (Experiment 2A) and required spice/herb extracts (Experiment 3) were prepared/obtained prior to the preparation of the curry.
a) The pre-cooked, dehydrated and oil free vegetable (96 g) derived from eight cups of freshly peeled and diced bottle gourd (1500 g) was taken in a suitable container.
b) The precooked vegetable base derived from two cups of tomato (366 g), two cups of diced onion (290 g) and six sliced green chillies (42 g) was added to the vegetable in step (a)
c) The components selected from steps (a) and (b) were mixed to obtain the blend
d) The blend in step ‘c’ was rehydrated with required amount of hot water to obtain the rehydrated/reconstituted blend
e) The rehydrated/reconstituted blend in step (d) was treated with required dosage of selected combination of spice/herb extracts equivalent to 5.90 g of Jeera, 32.17 g of fresh garlic, 6.67 g of curry leaves, 13.83 g of red chillies, and 2.50 g of turmeric in required quantity of vegetable oil.
f) Twenty grams of table salt was finally added to the mixture in step (e).
g) The contents were mixed well to obtain blend to eat bottle gourd food composition.

### Example 5: Preparation of Blend to Eat Ridge Gourd Food Composition (Ridge Gourd Curry; LFC002)

Ridge gourd curry was produced using the following process steps. The pre-cooked and dehydrated vegetable blend (90 g; Experiment 1B) derived from nine cups of freshly peeled and diced ridge gourd (1400 g) and two cups of tomato (366 g) pieces was taken in a suitable container. The precooked vegetable base derived 2 cups of diced fresh onion (290 g; Experiment 2D) was added to the vegetables and the contents were mixed gently. The mixture was rehydrated with required quantity of hot water to obtain rehydrated blend. The mixture of rehydrated blend of vegetables and vegetable base was treated with selected combination of spice/herb extracts (Experiment 3) equivalent to 5.90 g of Jeera, 32.17 g of fresh garlic, 6.67 g of curry leaves, 13.83 g of red chillies, and 2.50 g of turmeric in required quantity of vegetable oil. Twenty grams of table salt was finally added to the mixture. The contents were mixed well to obtain blend to eat ridge gourd food composition.

### Example 6

### Preparation of Regular Bottle Gourd Curry (LFC003) Using a Regular Cooking Process:

Cleaned bottle gourd was de-skinned, removed the seeds and cut in to small pieces and kept aside. Similarly, onions were peeled and diced into small pieces. Four large tomatoes were cleaned and cut into small pieces. Three table spoons (43 g) of oil was dispensed into pressure cooker pan and heated. The cumin seed (5.90 g), fresh garlic (32.17 g), red chillies (13.83 g), fresh curry leaves (6.67 g) and two cups of chopped onion (290 g) were added sequentially and the mixture was sautéed until onions were translucent. Then, eight cups of bottle gourd pieces (1500 g), two cups of tomato pieces (366 g) and six sliced green chillies were added to the pan followed by turmeric powder (2.50 g) and salt (20 g). The contents were mixed well and the cooker lid was closed along with the pressure regulator. The contents were allowed to cook for two whistles. The pressure was released and the contents were transferred to a serving bowl to obtain regular bottle gourd curry (LFC003).

Comparative Evaluation of Food Compositions from Conventional and Blend to Eat Versions of Different Recipes for Phytochemical Compounds

### Example 7

Preparation of Carrot Halwa in conventional cooking process: Carrots were washed, peeled and grated to obtain grated carrots. Almond and cashew nuts were chopped; green cardamom was powdered and kept side. Ghee (53) was dispensed in a heavy bottom pan and heated. The grated carrot (250 g) was added to the pan and cooked for 15 minutes until raw flavour of the carrot goes off. Diary cream (63 g) was then were added to the pan, the contents mixed and continued the cooking for 20 more minutes on low heat. Sugar syrup 80 g (40 g of sugar in 40 g of water) was added to the pan and continued the cooking for 20 more minutes. Ghee (10 g) was heated in a separate pan and fried the chopped cashew (7 g) and almonds (7 g). The mixture was added to the cooked carrot mixture and cooked for 5 more minutes. Cardamom powder (1 g) was finally added to the contents in the pan and mixed well to obtain halwa (270 g).

Preparation of Carrot Halwa in blend to eat (B2E) cooking process: Preparation of carrot Halwa sweet B2E food composition: The blend to eat carrot halwa sweet food composition was prepared using the following steps, a) The pre-cooked, dehydrated and oil free grated carrot vegetable (33.8 g) was taken in suitable container; b) To the container was added diary cream (63 g) and 80 g of sugar syrup (40 g of sugar and 40 g of water); c) The components from steps (a) and (b) were mixed to obtain the rehydrated blend; d) the blend in step (c) was rehydrated with 135 g of water by closing the lid and leaving the container aside for 5 minutes; e) The rehydrated blend in step (d) was treated with 4 drops of cardamom extract; f) The contents were mixed well to obtain blend to carrot halwa sweet blend to eat food composition; g) The food composition in step (f) was finally garnished with chopped cashew (7 g) and almond (7 g) fried in 35 g of ghee to obtain Carrot halwa (355 g).

These two recipes were subjected similar extraction process using hexane and the resultant extracts were concentrated. The extracts were diluted in equal volume of hexane. The carrot halwa extract samples prepared from the conventional and blend to eat cooking processes were analysed for β-Carotene concentration using HPLC method of analysis against β-Carotene reference standard and the results are summarized in the following table. The B2E food composition showed 114.3% improvement in β-Carotene concentration compared to the conventionally cooked sample.

| | | β-Carotene concentration | | % improvement |
|---|---|---|---|---|
| | | per 100 g in | | of B2E version |
| S. | Compound | Conventional | Blend to eat | over conventional |
| No | name | recipe | composition (B2E) | recipe |
| 1 | β-Carotene | 0.07 g | 0.15 g | 114.3% |

### Example 8

Preparation of Beetroot Halwa in conventional cooking process: Beetroots were washed, peeled and grated, Almond and cashew nuts were chopped; green cardamom was powdered and kept side. Ghee (70 g) was dispensed in a heavy bottom pan and heated. The grated beetroot (300 g) was added to the pan and cooked for 15 minutes until raw flavour of the beetroot goes off. Diary cream (60 g) was then were added to the pan, the contents mixed and continued the cooking for 20 more minutes on low heat. Sugar syrup (50 g of sugar in 50 g of water) was added to the pan and continued the cooking for 20 more minutes. Ghee was heated in a separate pan and fried the chopped cashew (10 g) and almonds (10 g). The mixture was added to the cooked beetroot mixture and cooked for 5 more minutes. Cardamom powder (2 g) was finally added to the contents in the pan and mixed well to obtain beetroot halwa (310 g).

Preparation of Beetroot Halwa in blend to eat (B2E) cooking process: Preparation of Beetroot Halwa sweet B2E food composition: The blend to eat beetroot halwa sweet food composition was prepared using the following steps, a) The pre-cooked, dehydrated and oil free grated beetroot vegetable (23.4 g) was taken in suitable container; b) To the container was add diary cream (50 g) and 70 g of sugar syrup (40 g of sugar and 30 g of water) and 30 g of ghee were added; c) The components from steps (a) and (b) were mixed to obtain the rehydrated blend; d) the blend in step (c) was rehydrated with 130 g of water by closing the lid and leaving the container aside for 5 minutes; e) The rehydrated blend in step (d) was treated with 3 drops of cardamom extract; f) The contents were mixed well to obtain blend to beetroot halwa sweet blend to eat food composition; g) The food composition in step (f) was finally garnished with chopped cashew (10 g) and almond (10 g) fried in 10 g of ghee to obtain beetroot halwa (320 g).

These two recipes were subjected similar extraction process using water and the extracts concentrated. The extracts were diluted in equal volume of water. The extract samples prepared from the conventional and blend to eat cooking processes were analysed for betanin concentration using HPLC method of analysis against betanin reference standard and the results are summarized in the following table. The B2E food composition showed 100% improvement in betanine concentration compared to the conventionally cooked sample.

| | | Betanin concentration per 100 g in | | % improvement |
|---|---|---|---|---|
| | | | Blend to eat | of B2E version |
| S. | Compound | Conventional | composition | over conventional |
| No | name | recipe | (B2E) | recipe |
| 1 | Betanin | 0.66 g | 1.32 g | 100% |

### Example 9

### Preparation and Analysis of Conventional and B2E Versions of the Tomato and Onion Curry Produced in B2E for Lycopene Content:

Preparation of Onion Tomato Masala Gravy curry using a regular cooking process: onions were peeled and chopped; tomatoes washed and chopped into small pieces. Sunflower oil (50 g) was dispensed into a thick bottom pan and heated. Then, chopped onion (220 g) were added and cooked till the onion gets golden brown color. Garlic paste (10 g), Ginger paste (10 g), and tomatoes (207 g) were added sequentially and the mixture was sautéed for 5 minutes. Then, turmeric powder (1.5 g), cumin powder (6 g), coriander powder (13.5 g), red chilli powder (9 g) were added and cooked for 15 minutes till the tomatoes were cooked. Water (150 g) and salt (3 g) were added to the pan and the contents were cooked with the lid closed until the raw masala flavor goes off. Then the contents were further cooked on an open pan for 10 more minutes on medium heat till the oil leaves the edges of the pan to obtain regular onion tomato curry. Total cooking time for the Mixed vegetable curry (275 g) was 45 minutes approximately.

### Onion Tomato Masala Curry—B2E Version:

Preparation of Onion Tomato Masala using B2E cooking process: The B2E version of the Onion Tomato Masala Gravy was prepared as per the following steps using precooked dehydrated and oil free vegetables and precooked Bases equivalent to their corresponding weights used in the regular cooking process described above. The spice extracts were used either at equivalent quantity or less than equivalent quantities compared to those used in the regular process disclosed above. a) Pre-cooked, dehydrated onions (29.3 g) tomatoes (11.6 g), ginger (1.42 g), garlic (3 g) were added to the container; b) The components from step (a) were mixed to obtain the blend; c) Boiling hot water (210 g) was added to the container having the blend of vegetables and bases from step (b); d) Then 47 drops (0.89 g) of cumin seed extract, 35 drops (0.5 g) of red chilli extract, 80 drops (1 g) of coriander extract, 2 drops of diluted turmeric extract (one-part turmeric extract is diluted with three parts edible oil) were added to the rehydrating vegetables bases; e) The contents were mixed well and covered with tight lid for 5 minutes; f) lid was opened, salt (3 g) and refined oil (15 g) were added and the contents were mixed gently and allowed to rehydrate for 2 more minutes to obtain B2E version of Onion Tomato Masala curry (275 g).

These two recipes were subjected similar extraction process using hexane and the extracts concentrated. The extracts were diluted in equal volume of hexane. The Onion Tomato Masala curry extract samples prepared from the conventional and blend to eat cooking processes were analysed qualitatively for Lycopene concentration using HPLC method of analysis and the results are summarized in the following table. The identity of Lycopene was confirmed using mass spectral analysis on TOF LC-MS/MS. The B2E food composition showed 497.33% improvement in Lycopene concentration compared to the conventionally cooked sample.

| | | Peak area for Lycopene for equal | | % improvement |
|---|---|---|---|---|
| | | dosing of hexane extract from | | of B2E version |
| S. | Compound | Conventional | Blend to eat | over conventional |
| No | name | recipe | composition (B2E) | recipe |
| 1 | Lycopene | 218012 | 1302262 | 497.33% |

### Example 10

Preparation of Mixed Vegetable Curry using a regular cooking process: Carrots were washed peeled and cut into 1 mm cubes; Green Beans were stringed, washed and cut into 1-inch dices, potatoes were peeled, washed and cut into small cubes; paneer (Indian Cottage cheese) was cut into cubes, Bell peppers and banana chilli were washed and cut into small pieces, Amaranths leaves were washed and shredded. All the preprocessed vegetables along with frozen thawed green peas, sweet corn were also kept ready. Similarly, onions were peeled and sliced, Tomatoes hybrid were cleaned and cut into small pieces. Sunflower oil (50 g) was dispensed in thick bottom pan and heated. Cumin seeds (1 g) were added to the pan and allowed to crackle. Then, sliced onion (200 g) was added and cooked till the onion turns golden brown color; then garlic paste (12 g), Ginger paste (12 g), green chopped chilli (8 g) and tomatoes (98 g) were added sequentially and the mixture was sautéed for 5 minutes. Then turmeric powder (0.75 g), coriander powder (3 g), red chilli powder (2.25 g) were added and cooked for 5 minutes till the raw flavor of spices goes off. Then, carrots (53 g), green beans (53 g), potato (53 g) were added to the pan, followed by Amaranths (50 g), bell pepper (53 g), banana chilli (53 g), green peas (45 g), sweet corn (53 g) and paneer (38 g). The mixture was cooked for 5 minutes followed by addition of water (120 g) and salt (6 g). The contents were further cooked with the lid closed till the vegetables get soft and tender. Then, garam masala (0.75 g), amchur powder (1 g) (dry mango) and coriander leaves (8 g) were added; and continued the cooking over medium heat on an open pan for 5 more minutes to obtain conventional mixed Vegetable Curry with desired consistency. The total cooking time for the Mixed vegetable curry was 40 minutes approximately.

### Preparation of Mixed Vegetable Curry Using B2E Cooking Process:

The B2E version of the Mixed vegetable curry was prepared as per the following steps using precooked, dehydrated and oil free vegetables and precooked bases equivalent to their corresponding weights used in the regular cooking process described above. The spice extracts were used either at equivalent quantity or less than equivalent quantities compared to those used in the regular process disclosed above. a) Pre-cooked, dehydrated and oil free dehydrated forms vegetables [carrots cubes (7.7 g), beans (53 g), potato cubes (7.3 g), sweet corn (11.1 g), green peas (11.3 g), bell peppers (4.25 g), Banana chilli (3.8 g), Panner (15.2 g), Amaranths (7.5 g)] were taken in a suitable container; b) Similarly, dehydrated bases [onions (29.5 g) tomatoes (4.6 g), ginger (1.4 g), garlic (4.2 g), amchur powder (1 g), green chili (1.1 g) and coriander leaves (1 g)] were added to the container; c) the components from the steps (a) and (b) were mixed to obtain the blend; d) Boiling hot water (460 g) was added to the container having blend of vegetables and bases from steps (a) and (b); e) Then, 3 drops of cumin seed extract, 5 drops red chili extract, 12 drops of coriander and 2 drops of diluted turmeric extract (one-part turmeric extract diluted with three parts edible oil) and 4 drops of garam masala extract, were added to the rehydrating vegetables; f) The contents were mixed well, covered with tight lid and allowed to rehydrate for 5 minutes, g) Opened the lid, added salt (4 g) and refined oil (15 g), mixed gently and leave it for 3 more minutes till the vegetables gets rehydrated thoroughly to obtain B2E mixed Vegetable Curry. It is ready to consume with choice of accompaniments.

These two food versions were then subjected to similar extraction process using hexane and concentrated. The concentrated extracts were then dissolved in equal volume of hexane and analysed using Agilent GC-HS/MS. The compounds were identified based on the molecular weight and comparison with the data in NIST standard reference database (Table 5).

TABLE 5
Phytochemical profile of spice compounds in Mixed Veg
curry prepared as per conventional and B2E processes

| | | | | | | % |
|---|---|---|---|---|---|---|
| | | | | | | Change |
| | | | | | | With |
| S. | | | Spice name it | Peak Area | | respect |
| No. | Compound Name | Mass | corresponds to | Recipe A | Recipe B | to B |
| 1 | 1,6-Octadiene-3-ol- | 71/93 | Coriander seed | 21538369 | ND | NA |
| | 3,7 dimethyl | | | | | |
| 2 | Cinnamaldehyde | 131 | Cinnamon tamala | 3562143 | ND | NA |
| 3 | Eugenol | 164 | Clove | 9063534 | ND | NA |
| 4 | Trans-Isoeugenol | 164 | Clove | 1991583 | ND | NA |
| 5 | Propanal-2-methyl-3- | 133/148 | Cumin | 15384124 | 11002918 | 39.81 |
| | phenyl | | | | | |

ND: not detected;
NA: not apply;
Recipe A is B2E and
Recipe B is Conventional

### Example 11

Preparation of Dal Amaranths using a regular cooking process: Toor dal (Split yellow pigeon peas) (50 g) was washed and kept aside; fresh Amaranths leaves (80 g) were sorted, washed, shredded and kept aside. Similarly, country tomatoes were washed and chopped into small pieces. Sunflower oil (20 g) was dispensed into pressure cooker pan and heated. Cumin seeds (2 g) and red chilli whole (2 g) were added to the oil and allowed to crackle. Then, garlic (5.5 g), chopped ginger (12 g), fresh green chilli slices (5 g), fresh curry leaves (1.5 g) were added sequentially and the mixture was sautéed for 3 minutes. Amaranths leaves and chopped tomato (85 g) were added to the pan and sautéed for 7 minutes. The washed lentils, turmeric powder (1 g), water (400 g) and salt (4 g) were added to the cooker pan and mixed well. The cooker lid was closed along with the pressure regulator. The contents were allowed to cook on medium heat for three whistles and the heat was turned off. The cooker was then rested for few minutes and then released the pressure. The contents were further cooked on an open pan for 5 minutes to get the dal mashed and to obtain conventional Dal Amaranthus (590 g). Total cooking time for the Dal amaranths was 35 minutes approximately.

### Preparation of Dal Amaranths Using B2E Cooking Process:

The B2E version of the Dal Amaranthus was prepared as per the following steps using precooked dehydrated and oil free vegetables and precooked Bases equivalent to their corresponding weights used in the regular cooking process described above. The spice extracts were used either at equivalent quantity or less than equivalent quantities compared to those used in the regular process disclosed above. a) precooked, dehydrated and oil free Amaranthus (12 g) and Toor dal (40 g) were taken in a suitable container; b) Similarly, chopped dehydrated tomatoes (4 g), dehydrated spices [garlic (1.9 g), ginger (1.4 g), green chilli slices (1.1 g) and curry leaves (0.18 g)] were added to the container; c) the components from the steps (a) and (b) were mixed to obtain the blend; d) Boiling hot water (520 g) was added to the container having the blend in step (c); e) Then, 2 drops of cumin seed extract, 1 drop of red chili extract and 1 drop of diluted turmeric extract (one-part turmeric extract diluted with three parts edible oil) were added to the rehydrating vegetables; f) The contents were mixed well and covered with tight lid for 5 minutes to rehydrate, g) Open lid and added salt (2.5 g) and refined oil (5 g) and mixed gently to obtain B2E Dal Amaranthus (590 g).

These two food versions were then subjected to similar extraction process using hexane and concentrated. The concentrated extracts were then dissolved in equal volume of hexane and analysed using Agilent GC-HS/MS. The compounds were identified based on the molecular weight and comparison with the data in NIST standard reference database (Table 6).

TABLE 6
Phytochemical profile of spice compounds in Dal Amaranthus
curry prepared as per conventional and B2E processes

| | | | | | | % |
|---|---|---|---|---|---|---|
| | | | | | | Change |
| | | | | | | With |
| S. | | | Spice name it | Peak Area | | respect |
| No. | Compound Name | Mass | corresponds to | Recipe A | Recipe B | to B |
| 1 | Beta-pinene | 93 | — | 23765243 | 5330384 | 345.84 |
| 2 | Gama-Terpinene | 93 | Cumin | 21156484 | ND | NA |
| 3 | Propanal-2-methyl-3- | 133/148 | Cumin | 142479608 | 14685636 | 870.20 |
| | phenyl | | | | | |
| 4 | 3-Caren-10-al/2- | 107/79 | Cumin | 50542416 | 3958519 | 1176.8 |
| | Caren-10-al | | | | | |
| 5 | 3-Caren-10-al/2- | 107/79 | Cumin | 11491079 | 5878841 | 95.46 |
| | Caren-10-al | | | | | |

ND: not detected,
NA: not apply;
Recipe A is B2E and
Recipe B is Conventional

### Example 12

Preparation of bottle gourd fry using a regular cooking process: Bottle gourd and onions were peeled, cut into small pieces and kept aside. Tomatoes were cleaned and cut into small pieces. Sunflower oil (21.5 g) was dispensed into a pressure cooker pan and heated. Diced garlic (8 g), green chilli sliced (10.5 g), fresh curry leaves (1.66 g) and onions (72.5 g) were added sequentially to the pan and the mixture was sautéed until onions were translucent. Then, bottle gourd pieces (375 g) and chopped tomato (91.5 g) were added to the pan followed by turmeric powder (0.62 g), red chilli powder (3.5 g), cumin powder (1.5 g) and salt (5 g). The contents were mixed well and the cooker lid was closed along with the pressure regulator. The contents were allowed to cook on medium flame for two whistles and the heat is then turned off. The cooker is then rested for few minutes, released the pressure and opened the lid. The contents were further cooked on an open pan for 5 more minutes to obtain conventional Bottle Gourd Fry with achieve desired consistency. Total cooking time for the Bottle Gourd Fry would be 35 minutes approximately

### Preparation of Bottle Gourd Fry Using Blend to Eat(B2E) Cooking Process:

The B2E version of the Bottle Gourd Curry was prepared as per the following steps using precooked dehydrated and oil free vegetables and precooked bases equivalent to their corresponding weights used in the regular cooking process described above. The spice extracts were used either at equivalent quantity or less than equivalent quantities compared to those used in the regular process disclosed above. a) Dehydrated Bottle Gourd cubes (15.9 g) were taken in a suitable container; b) Similarly, dehydrated chopped onions (10.6 g), chopped dehydrated tomatoes (5.6 g), dehydrated garlic (2.8 g), green chili (1.4 g) and curry leaves (0.2 g) were added to the container; c) the components from the steps (a) and (b) were mixed to obtain the blend; d) Boiling hot water (270 g) was added to the blend in step (c); e) Then, 3 drops of cumin seed extract, 7 drops red chili extract and 1 drop of diluted turmeric extract (one-part turmeric extract is diluted with three parts edible oil) were added to the rehydrating vegetables; f) The contents were mixed well and covered with tight lid for 5 minutes, g) Open the lid, add salt (3 g) and refined oil (5 g), mixed gently and left for 2 more minutes to obtain B2E version of the Bottle Gourd Fry.

These two food versions were then subjected to similar extraction process using hexane and concentrated. The concentrated extracts were then dissolved in equal volume of hexane and analysed using Agilent GC-HS/MS. The compounds were identified based on the molecular weight and comparison with the data in NIST standard reference database (Table 7).

TABLE 7
Phytochemical profile of spice compounds in Bottle gourd
fry curry prepared as per conventional and B2E processes

| | | | | | | % |
|---|---|---|---|---|---|---|
| | | | | | | Change |
| | | | | | | With |
| S. | | | Spice name it | Peak Area | | respect |
| No. | Compound Name | Mass | corresponds to | Recipe A | Recipe B | to B |
| 1 | Ar-Turmerone | 83/119 | Turmeric | 1975928 | 1628415 | 21.34 |
| 2 | Caryophyllene | 93/133 | Curry leaves | 1470069 | 1437274 | 2.28 |
| 3 | Propanal-2-methyl-3- | 133/148 | Cumin | 95640258 | 11611235 | 723.68 |
| | phenyl | | | | | |
| 4 | 3-Caren-10-al/2- | 107/79 | Cumin | 42359031 | 6531244 | 548.56 |
| | Caren-10-al | | | | | |
| 5 | 3-Caren-10-al/2- | 107/79 | Cumin | 2860480 | ND | NA |
| | Caren-10-al | | | | | |

ND: Not detected,
NA: Not available;
Recipe A is B2E and
Recipe B is Conventional

### Example 13

Preparation of Ridge gourd curry using regular cooking process: The Ridge gourd was cleaned, deskinned, deseeded, cut into pieces and kept ready. Similarly, tomatoes and onions were cleaned and diced into small pieces; garlic was diced into fine paste. Sunflower oil (21 g) was added to a cooker pan and heated. Onions (72.5 g) were added to the pan and are sautéed till translucent. Then, finely diced garlic (8 g), cumin powder (1.5 g), turmeric powder (0.62 g), red chili powder (3.5 g), chopped tomatoes (92 g) and ridge gourd pieces (350 g) were added to the cooker and sautéed for 5 minutes. Finally, water (50 g) and salt (5 g) were added to the pressure cooker, the contents were stirred and cooked with the lid closed along with the pressure regulator for two whistles. The cooker was then rested till the pressure gets released. The cooking was continued on an open pan for 5 more minutes to obtain the conventionally cooked Ridge gourd curry (516 g). The total cooking time for the Ridge Gourd Fry would be 35 minutes approximately

### Preparation of Ridge Gourd Curry Using B2E Cooking Process:

The B2E version of the Vegetable Pulao was prepared as per the following steps using precooked dehydrated and oil free vegetables and precooked Bases equivalent to their corresponding weights used in the regular cooking process described above. The spice extracts were used either at equivalent quantity or less than equivalent quantities compared to those used in the regular process disclosed above. a) Dehydrated Ridge Gourd cubes (16.8 g) were taken into a suitable container with lid; b) Similarly, dehydrated chopped onions (10.66 g), chopped dehydrated tomatoes (5.6 g), dehydrated garlic (2.8 g) and curry leaves (0.2 g) were added to the container; c) The components from the steps (a) and (b) were mixed to obtain the blend; d) Boiling Hot water (474 g) was added to the container with the vegetables and bases from steps (a) and (b); e) Then, 3 drops of cumin seed extract, 7 drops red chili extract and 1 drop of diluted turmeric extract (one-part turmeric extract is diluted with three parts edible oil) were added to the rehydrating vegetables; f) The contents were mixed well and covered with tight lid for 5 minutes. g) The lid was opened to add salt (5 g) and refined oil (1 g); mixed gently and left for 2 more minutes so the vegetables get rehydrated thoroughly to obtain B2E version of Ridge gourd curry (516 g).

These two food versions were then subjected to similar extraction process using hexane and concentrated. The concentrated extracts were then dissolved in equal volume of hexane and analysed using Agilent GC-HS/MS. The compounds were identified based on the molecular weight and comparison with the data in NIST standard reference database (Table 7A).

TABLE 7A
Phytochemical profile of spice compounds in Ridge gourd
curry prepared as per conventional and B2E processes

| | | | | | | % Change |
|---|---|---|---|---|---|---|
| S. | | | | Peak Area | | With respect |
| No. | Compound Name | Mass | Spice Source | Recipe A | Recipe B | to B |
| 1 | Caryophyllene | 164 | Clove | 727181 | ND | NA |
| 2 | Propanal-2-methyl-3- | 133/148 | Cumin | 37527538 | 12659615 | 196.4 |
| | phenyl | | | | | |
| 3 | 3-Caren-10-al/2- | 107/79 | Cumin | 17852066 | 2533658 | 604.6 |
| | Caren-10-al | | | | | |

ND: not detected;
NA: not apply;
Recipe A is B2E and
Recipe B is Conventional

### Example 14

Preparation of Vegetable Pulao using a regular cooking process: Raw basmati rice (300 g) was taken in a bowl, washed for 15 minutes and drained for 10 minutes. Carrots were washed peeled and cut into 1 mm cubes; green beans were stringed, washed and cut into 1-inch dice, potatoes washed and cut into small cubes; button mushrooms were washed and sliced. All the preprocessed vegetables were kept aside along with thawed frozen green peas. Similarly, red onions were peeled and sliced, tomatoes, mint leaves and coriander leaves were cleaned, washed, chopped and kept aside along with ginger paste, garlic paste and green chilli paste. Sunflower oil (40 g) was dispensed into a thick bottomed pan and heated. Sliced onion (200 g) was added and cooked till the onion turns to golden brown color. Then garlic paste (10 g), ginger paste (10 g), green chilli paste (10 g) and tomatoes (100 g) were added sequentially and the mixture was sautéed for 5 minutes. Then, red chilli powder (15 g) was added to the mixture and cooked for 5 minutes. Preprocessed carrots (50 g), green beans (50 g), potato (50 g) were added to the pan followed by green peas (50 g) and mushroom (20 g); and then cooked for 5 more minutes. Basmati rice, hot water (500 g) and salt (17 g) were added to the pan. The mixture was brought to simmer and garam masala (2.5 g) was added. The contents were mixed well, following which the lid of the pan was closed and cooked for 15 minutes. The lid is opened and chopped mint leaves (10 g), chopped coriander leaves (10 g) and ghee (30 g) were quickly added and mixed gently. The lid was closed again tightly and the contents were cooked for 15 minutes on a low heat. The heat was turned off and the contents were gently transferred to a serving bowl to obtain Conventional Vegetable Pulao (839 g). Total cooking time for the Vegetable Pulao would be 60 minutes approximately.

### Preparation of Vegetable Pulao Using B2E Cooking Process:

The B2E version of the Vegetable Pulao was prepared as per the following steps using precooked, dehydrated and oil free vegetables and precooked bases equivalent to their corresponding weights used in the regular cooking process described above. The spice extracts were used either at equivalent quantity or less than equivalent quantities compared to those used in the regular process disclosed above. a) Pre-Cooked oil free dehydrated carrots cubes (7.25 g), beans (5 g), potato cubes (7 g), green peas (12.5 g), mushroom (1.32 g) were taken in a suitable container: b) Similarly, dehydrated onions (29.4 g) tomatoes (4.7 g), ginger (1.2 g), garlic (3.5 g), green chili (1.4 g), coriander leaves(1.1 g) and mint leaves (2.3 g) were added to the container along with precooked and dehydrated basmati rice (267 g); c) the components from the steps (a) and (b) were mixed to obtain the blend; d) Boiling hot water (470 g) was added to the container having the vegetables and bases from steps (a) and (b); e) Then. 18 drops of garam masala extract, 6 drops red chili extract, 12 drops of coriander extract and 2 drops of diluted turmeric extract (one-part turmeric extract is diluted with three parts edible oil) were added to the rehydrating vegetables; e) The contents were mixed well and covered with tight lid for 5 minutes; f) Lid was opened and added salt (12 g), refined oil (10 g) and Ghee (10 g); the contents were mixed gently and left it for 2 minutes to rehydrate the vegetables and rice thoroughly to obtain B2E version of Vegetable pulao. These two food versions were then subjected to similar extraction process using hexane and concentrated. The concentrated extracts were then dissolved in equal volume of hexane and analysed using Agilent GC-HS/MS. The compounds were identified based on the molecular weight and comparison with the data in NIST standard reference database (Table 8).

TABLE 8
Phytochemical profile of spice compounds in Vegetable
pulao prepared as per conventional and B2E processes

| | | | | Peak Area | |
|---|---|---|---|---|---|
| S. | Compound | | Spice | Recipe | Recipe |
| No. | Name | Mass | Source | A | B |
| 1 | Cinnamaldehyde | 131/103 | Cinnamom | 17250667 | ND |
| | | | tamala | | |
| 2 | Anethole | 148 | Fennel | 11082274 | ND |
| 3 | Eucalyptol | 81/108 | Cardamom | 13082240 | ND |
| | | | green | | |
| 4 | Eugenol | 164 | Clove | 38219545 | ND |
| 5 | Trans-Isoeugenol | 164 | Clove | 10487688 | ND |

ND: not detected; Recipe A is B2E and Recipe B is Conventional

### Comparative Evaluation of Conventional and Blend to Eat Versions of Different Recipes for Nutritional Parameters.

### Example 15

Evaluation of conventional and B2E versions of Mixed Vegetable Curry for nutritional parameters: The samples of the conventional (620 g) and B2E (715 g) versions of Mixed Vegetable Curry prepared as disclosed in Example 10 were evaluated for nutritional parameters such as protein, dietary fiber, carbohydrate, energy, fat and vitamins. The observed nutrient values were converted into nutrient values in total weight of the recipe samples prepared and the results are summarized in Table 9.

TABLE 9
Nutritional data of Conventional and
B2E version of Mixed Vegetable Curry

| | | | | % Change |
|---|---|---|---|---|
| | | | | in B2E |
| | | | | version |
| | | | | compared to |
| Nutritional | Unit of | Conventional | | conventional |
| Parameter | nutrition | version | B2E version | version |
| Protein | g | 19.34 | 27.24 | 40.83 |
| Dietary Fiber | g | 23.56 | 27.88 | 18.36 |
| Total | g | 73.47 | 89.44 | 21.75 |
| Carbohydrates | | | | |
| Total Fat | g | 69.19 | 21.73 | −68.59 |
| Vitamin K | μg | 64.79 | 171.31 | 164.41 |

### Example 16

### Mixed Vegetable Sambar:

Preparation of the sambar using a regular cooking process: Toor dal (Split yellow pigeon peas raw; 50 g) was washed and kept aside, Ridge Gourd (25 g) and Drumstick (25 g) and Beans (15 g), carrot (15 g) washed, peeled, stringed and cut into pieces and kept aside. Similarly, Onion (15 g), shallots (25 g), tomatoes (50 g) were washed and chopped into small pieces. Washed lentil (50 g), turmeric powder (0.5 g) and water (150 g) were added to a pressure cooker and cooked for 2 whistles; the cooker was then rested till the pressure got released. The contents of the pressure cooker were transferred to a suitable bowl and the pressure cooker was washed for reuse. Sunflower oil (20 g) was dispensed into the pressure cooker pan and heated, cumin seeds whole (1 g) and red chilli whole (1 g) and mustard seeds (0.5 g) were added to the oil and allowed to crackle. Then, fresh curry leaves (1 g), onion (15 g), shallots (25 g), garlic whole pods (5 g) were added sequentially and the mixture was sautéed until onions gets translucent. Then, drumstick, ridge gourd, carrot and beans, followed by chilli powder (1 g), sambar powder (2.5 g), chopped tomato (50 g) were added to the pan and sautéed for 5 minutes, Then, already cooked toor dal mentioned above and salt (5 g) were added to the pressure cooker pan. The contents were mixed well and the cooker lid was closed along with the pressure regulator and contents were allowed to cook for 1 whistle on a medium heat. The pressure cooker was rested till the pressure got released. The contents were further cooked on an open pan for 5 minutes after adding water (100 g), tamarind paste (5 g). Finally, ghee (3 g) and coriander leaves (4 g) were added to the dish to obtain regular vegetable sambar (550 g). Total cooking time for the mixed vegetable sambar was 40 minutes approximately

Preparation of Vegetable Sambar using B2E cooking process: The B2E version of the vegetable sambar was prepared as per the following steps using precooked dehydrated and oil free vegetables and precooked bases equivalent to their corresponding weights used in the regular cooking process described above. The spice extracts were used either at quantities equivalent or less than equivalent quantities compared to their corresponding raw spices quantities used in the regular process disclosed above. a) Pre-cooked dehydrated and oil free drumstick (2.75 g) and Carrot (1.25 g), ridge gourd (1.35 g), beans (1.5 g) were taken in a suitable container; b) Similarly, chopped dehydrated forms of onions (2.15 g), shallots (4.5 g) tomatoes (3 g), garlic (1.5 g) and curry leaves (0.35 g) and toor dal (40 g) were added to the container; c) The components selected from steps (a) and (b) were mixed to obtain the blend; d) Boiling water (580 g) was added to the container having the blend from step (c); e) Then 1 drop of cumin seed extracts, 1 drop mustard seeds extract, 4 drops of red chilli extract and 1 drop of diluted turmeric extract (one-part turmeric extract diluted with three parts edible oil), 5 drops of sambar powder extract were added to the rehydrating vegetables; f) The contents were mixed well and covered with tight lid for 5 minutes to rehydrate, g) Opened lid and added salt (3 g) refined oil (5 g), ghee (5 g) and tamarind paste (4 g) and the contents were mixed gently to obtain B2E version of the mixed vegetable Sambar (640 g).

The samples of the conventional and B2E versions evaluated for nutritional parameters such as protein, dietary fiber, carbohydrate, energy, fat and vitamins. The observed nutrient values were converted into nutrient values in total weight of the recipe samples prepared and the results are summarized in Table 10.

TABLE 10
Nutritional data of Conventional and
B2E version of Vegetable Sambar

| | | | | % Change |
|---|---|---|---|---|
| | | | | in B2E |
| | | Vegetable | | version |
| | | sambar | | compared to |
| Nutritional | Unit of | Conventionally | | conventional |
| Parameter | nutrition | cooked version | B2E version | version |
| Protein | g | 20.185 | 23.36 | 15.73 |
| Dietary Fibers | g | 23.595 | 25.344 | 7.41 |
| Total | g | 65.505 | 71.744 | 9.52 |
| Carbohydrates | | | | |
| Total Fat | g | 28.71 | 11.328 | −60.54 |
| Vitamin E | mg | 16.445 | 19.52 | 18.70 |
| Vitamin K | μg | ND | 84.61 | NA |

ND: not detected; NA: not apply

### Example 17

### Bottle Gourd Curry

Preparation of bottle gourd curry using a regular cooking process: Bottle gourd and onions were cleaned, peeled, and cut into small pieces and kept aside. Tomatoes were cleaned and cut into small pieces. Sunflower oil (21.5 g) was dispensed into a pressure cooker pan and heated. Diced garlic (8 g), green chilli sliced (10.5 g), fresh curry leaves (1.66 g) and onions (72.5 g) were added sequentially to the pan and the mixture was sautéed until onions were translucent. Then, bottle gourd pieces (375 g) and chopped tomato (91.5 g) were added to the pan followed by turmeric powder (0.62 g), red chilli powder (3.5 g), cumin powder (1.5 g) and salt (5 g). The contents were mixed well and the cooker lid was closed along with the pressure regulator. The contents were allowed to cook on medium flame for two whistles and the heat is then turned off. The cooker is then rested until the pressure gets released. The contents were further cooked on an open pan for 5 more minutes to achieve desired consistency to obtain conventional Bottle Gourd curry (480 g). Total cooking time for the Bottle Gourd curry was 35 minutes approximately

### Bottle Gourd Curry—B2E Version:

### Preparation of Bottle Gourd Curry Using Blend to Eat (B2E) Cooking Process:

The B2E version of the Bottle Gourd Curry was prepared as per the following steps using precooked, dehydrated and oil free vegetables and precooked bases equivalent to their corresponding weights used in the regular cooking process described above. The spice extracts were used either at equivalent quantity or less than equivalent quantities compared to those used in the regular process disclosed above. a) Dehydrated bottle gourd cubes (12.6 g) were taken in a suitable container with lid; b) Similarly, dehydrated chopped onions (10.66 g), chopped dehydrated tomatoes (4.8 g), dehydrated forms of garlic (2.8 g), green chili (1.45 g) and curry leaves (0.20 g) were added to the container; c) The components selected from steps (a) and (b) were mixed to obtain the blend; d) Boiling water (500 g) was added to the container having the blend from step (c); e) Then, 3 drops of cumin seed extract, 7 drops red chili extract and 1 drop of diluted turmeric extract (one-part turmeric extract is diluted with three parts edible oil) were added to the rehydrating vegetables; e) The contents were mixed well and covered with tight lid for 5 minutes. f) Open lid and added salt (3 g) and refined oil (5 g), mixed gently and allow the contents to rehydrate for 2 more minutes to obtain B2E version of the Bottle Gourd curry (543 g).

The samples of the conventional and B2E versions of Bottle Gourd curry were evaluated for nutritional parameters such as protein, dietary fiber, carbohydrate, energy, fat and vitamins. The observed nutrient values were converted to nutrient values in total weight of the recipe samples prepared and the results are summarized in Table 11.

TABLE 11
Nutritional profiles of Bottle Gourd curry
prepared in conventional and B2E processes.

| | | | | % Change |
|---|---|---|---|---|
| | | | | in B2E |
| | | Bottle Gourd | | version |
| | | curry | | compared to |
| Nutritional | Unit of | Conventionally | | conventional |
| Parameter | nutrition | cooked version | B2E version | version |
| Protein | g | 4.32 | 8.964 | 107.5 |
| Dietary Fiber | g | 12.912 | 15.444 | 19.61 |
| Energy | kcal | 295.44 | 134.136 | −54.56 |
| Total | g | 36.144 | 45.63 | 26.25 |
| Carbohydrates | | | | |
| Total Fat | g | 17.712 | 3.672 | −79.27 |

### Example 18

### Mixed Vegetable Curry

### Mixed Vegetable Curry: High Fibrous Version (Spiked)

Preparation of the mixed vegetable Curry using a regular cooking process: Carrot (75 g washed, peeled and cut into pieces and kept aside. Purple Cabbage (75 g) and white cabbage(75 g) were cut into thick strips, cluster beans (50 g) and green beans (100 g) washed, strings removed and cut into pieces, frozen green peas (50 g) were thawed and kept aside. Similarly, Onion (150 g), tomatoes (50 g) garlic pods (10 g), green chillies (25 g) were washed and chopped into small pieces. The onions were then spiked with known amounts of vitamins (10 mg of Vitamin B12, 20 mg of Vitamin D3, 200 mg of Vitamin E and 60 mg of Vitamin A). Sunflower oil (50 g) was dispensed into the thick bottomed pan and heated, cumin seeds whole (1 g) and mustard seeds (1 g) were added to the oil and allowed to crackle. Then, fresh curry leaves (5 g), onion (150 g), garlic (10 g), green chilli (25 g) were added sequentially and the mixture was sautéed until onions gets translucent. Then chopped tomato (50 g) were added to the pan and sautéed for 5 minutes. Then, turmeric powder(0.5 g) red chilli powder (2 g), coriander powder(3 g), garam masala powder(2 g) and salt (4 g) were added to the mixture. The contents were mixed well and cooked for 5 minutes till the raw flavour of masala-spice powders goes off, then carrots, beans, cabbage white and purple, cluster beans, green peas and water (50 g) were added and cooked till the vegetables are tender and soft, Finally, coriander leaves(5 g) were added to the dish to obtain regular Mixed Vegetable Curry (420 g). Total cooking time for the mixed vegetable curry was 40 minutes approximately

### Mixed Vegetable Curry: High Fibrous and B2E Version (Spiked)

Preparation of Mixed Vegetable Curry using B2E cooking process: The onions used in this dish were peeled, sliced and spiked with known amounts of vitamins (10 mg of Vitamin B12, 20 mg of VitaminD3, 200 mg of Vitamin E and 60 mg of Vitamin A). The spiked batch of onions went through the standard cooking and dehydration process used for all the vegetables in B2E process. The B2E version of the mixed vegetable curry was prepared as per the following steps using precooked dehydrated and oil free vegetables and precooked bases equivalent to their corresponding weights used in the regular cooking process described above. The spice extracts were used either at quantities equivalent or less than equivalent quantities compared to their corresponding raw spices quantities used in the regular process disclosed above, a) Pre-cooked dehydrated and oil free Carrot (10.8 g), green Beans(10 g), Cluster beans(8.6 g), purple cabbage(7.1 g), white cabbage(6.3 g) and Green peas(12.5 g) were taken in a suitable container; b) Similarly, chopped dehydrated forms of onions (22 g),tomatoes (2.6 g), garlic (1 g), green chilli(3.4 g) and curry leaves (1.5 g) Coriander leaves(0.6 g) were added to the container; c) The components selected from steps (a) and (b) were mixed to obtain the blend; d) Boiling water (365 g) was added to the container having the blend from step (c); e) Then 1 drop of cumin seed extracts, 1 drop mustard seeds extract, 2 drops of red chilli extract, 3 drops of coriander and 1 drop of diluted turmeric extract (one-part turmeric extract is diluted with three parts edible oil), 2 drops of garam masala extract were added to the rehydrating vegetables; f) The contents were mixed well and covered with tight lid for 5 minutes to rehydrate, g) Opened lid and added salt (3 g) refined oil (5 g) and the contents were mixed gently to obtain B2E version of the mixed vegetable Curry (490 g).

The samples of the conventional and B2E versions of Mixed veg Curry were evaluated for nutritional parameters such as protein, dietary fiber, carbohydrate, energy, fat and vitamins. The observed nutrient values were converted into nutrient values in total weight of the recipe samples prepared and the results are summarized in Table 12.

TABLE 12
Nutritional profiles of Mixed Vegetable curry
prepared in conventional and B2E processes

| | | | | % Change |
|---|---|---|---|---|
| | | | | in B2E |
| | | Mixed | | version |
| | | Vegetable | | compared to |
| Nutritional | Unit of | Conventionally | | conventional |
| Parameter | nutrition | cooked version | B2E version | version |
| Protein | g | 13.19 | 18.23 | 38.21 |
| Dietary Fiber | g | 23.73 | 26.17 | 10.28 |
| Energy | kcal | 732.14 | 446.49 | −39.01 |
| Total | g | 70.39 | 70.71 | 0.45 |
| Carbohydrates | | | | |
| Total Fat | g | 49.48 | 10.98 | −77.81 |
| Vitamin E | mg | 170.94 | 231.18 | 35.24 |
| Vitamin K | μg | 156.66 | 228.14 | 45.63 |
| Vitamin B12 | μg | 3669.96 | 8697.99 | 137.01 |
| Vitamin A | IU | 14771.4 | 21638.00 | 46.49 |
| Vitamin D3 | μg | 6926.43 | 7954.22 | 14.84 |

### Example 19

### Dal Palak—Spinach and Lentil Curry

Preparation of Dal Palak (Spinach and Lentil Curry) using a regular cooking process: Spinach leaves were washed and cut into strips/length wise and kept aside. Mix 3 variants of lentils, Channa dal (15 g), toor dal (10 g) and moong dal (50 g) were washed and kept aside. Similarly, onions were peeled and chopped; the onions were then spiked with known amounts of vitamins (2.5 mg of Vitamin B12, 5 mg of Vitamin D3, 50 mg of Vitamin E and 15 mg of Vitamin A); tomatoes (25 g), ginger (2.5 g), garlic (5 g) and green chillis (5 g) were chopped and kept aside. In a pressure cooker, Chana dal, toor dal and moong dal were added along with water (300 g) and the contents were cooked for 2 whistles. The pressure cooker was then rested till the pressure got released, Sunflower oil (25 g) was dispensed into thick bottom pan and heated. Cumin seeds (0.5 g) and red chilli whole (1 g) were added to the pan and were allowed to crackle. Then, fresh diced ginger (2.5 g), garlic (5 g), green chilli sliced (5 g), onions (25 g) and turmeric powder (0.25 g) were added sequentially and the mixture was sautéed until onions turned translucent. Then, tomatoes (25 g) and spinach (100 g) were added and cooked for 5 minutes followed by addition of salt (3.5 g). The contents were transferred to pressure cooker pan containing the dals. Then, the lid was closed and cooked for 1 whistle, the cooker was allowed to rest till the pressure got released. Coriander leaves (1 g) and ghee (10 g) were added, then the contents were transferred to a serving bowl to obtain regular Dal Palak (Spinach and Lentil Curry), Total cooking time for the Dal palak (Spinach and Lentil Curry) was 35 minutes approximately

### Dal Palak—Spinach and Lentil Curry—B2E Version:

Preparation of Dal Palak (lentil Spinach Curry) in B2E process: The onions used in this dish were peeled, sliced and spiked with known amounts of vitamins (2.5 mg of Vitamin B12, 5 mg of VitaminD3, 50 mg of Vitamin E and 15 mg of Vitamin A). The spiked batch of onions went through the standard cooking and dehydration process used for all the vegetables in B2E process. The B2E version of the spinach, lentils and vegetable bases was prepared as per the following steps using precooked dehydrated and oil free vegetables and precooked and dehydrated bases equivalent to their corresponding weights used in the regular cooking process described above. The spice extracts were used either at equivalent quantity or less than equivalent quantities compared to those used in the regular process disclosed above. a) Pre-cooked, dehydrated and oil free dehydrated Spinach (6.1 gi were taken in a suitable container; b) Similarly, dehydrated Lentils [Channa dal (13.9 g), toor dal (9 g), moong dal (47.6 g)] followed by chopped, spiked, cooked and dehydrated onions (3.3 g), chopped and dehydrated forms of tomatoes (1.4 g), ginger (0.35 g), garlic (1.5 g), green chili (0.53 g) were added to the container; c) The components selected from steps (a) and (b) were mixed to obtain the blend; d) Boiling water (375 g) was added to the container having the blend in step (c); e) Then, 1 drop of cumin and 1 drop of mustard seed extracts, 3 drops of red chili extract and 1 drop of diluted turmeric extract (1 part turmeric extract+3 drops vegetable oil) were added to the rehydrating vegetables; f) The contents were mixed well and covered with tight lid for 5 minutes to rehydrate, g) The lid was opened and added salt (2 g) and refined oil (10 g), ghee (5 g) followed by a gentle mix to obtain B2E version of Dal Palak (Spinach Lentil Curry; 533 g).

The samples of the conventional and B2E versions of Dal Palak were evaluated for nutritional parameters such as protein, dietary fiber, carbohydrate, energy, fat and vitamins. The observed nutrient values were converted into nutrient values in total weight of the recipe samples prepared and the results are summarized in Table 13.

TABLE 13
Nutritional data for Dal Palk (Spinach Lentil Curry)
prepared in conventional and B2E cooking processes.

| | | | | % Change in B2E |
|---|---|---|---|---|
| | | | | version |
| | | | | compared to |
| Nutritional | Unit of | Conventionally | | conventional |
| Parameter | nutrition | cooked | B2E | version |
| Protein | g | 16.79 | 19.61 | 16.80 |
| Dietary Fiber | g | 38.45 | 48.29 | 25.59 |
| Energy | kcal | 387.05 | 274.02 | −29.20 |
| Total | g | 42.30 | 57.19 | 35.20 |
| Carbohydrates | | | | |
| Total Fat | g | 25.30 | 7.04 | −72.19 |
| Vitamin E | mg | 26.99 | 33.85 | 25.41 |
| Vitamin B12 | μg | 1603.17 | 2157.05 | 34.55 |
| Vitamin A | IU | 0.54 | 0.65 | 20.10 |
| Vitamin D3 | μg | 614.07 | 916.55 | 49.26 |

### Example 20

### Carrot and Bottle Gourd Sambar:

Preparation of the sambar using a regular cooking process: Toor dal (Split yellow pigeon peas raw; 50 g) was washed and kept aside; Carrot and Bottle gourd were washed, cleaned, peeled and cut into pieces and kept aside. Similarly, Onion, shallots, tomatoes were washed and chopped into small pieces. The onions were then spiked with known amounts of vitamins (2.5 mg of Vitamin B12, 5 mg of VitaminD3, 50 mg of Vitamin E and 15 mg of Vitamin A). Washed Toor dal (50 g), turmeric powder (0.5 g) and water (300 g) were added to a pressure cooker and cooked for 2 whistles, and the cooker was then rested till the pressure got released. The contents of the pressure cooker were transferred to a suitable bowl and the pressure cooker was washed for reuse. Sunflower oil (20 g) was dispensed into the pressure cooker pan and heated, cumin seeds whole (1 g) and red chilli whole (1 g), fenugreek (0.5 g) and mustard seeds (0.5 g) were added to the oil and allowed to crackle. Then, fresh curry leaves (1 g), onion (15 g), shallots (25 g), garlic whole pods (5 g) were added sequentially and the mixture was sautéed until onions gets translucent. Then, bottle gourd (40 g) and carrot (40 g), followed by chilli powder (1 g), sambar powder (2.5 g), chopped tomato (50 g) were added to the pan and sautéed for 5 minutes, Then, already cooked toor dal mentioned above and salt (5 g) were added to the pressure cooker pan. The contents were mixed well and the cooker lid was closed along with the pressure regulator and the contents were allowed to cook for 1 whistle on a medium heat. The pressure cooker was rested till the pressure got released. The contents were further cooked on an open pan for 5 minutes after adding tamarind paste (5 g). Finally, ghee (3 g) and coriander leaves(4 g) were added to the dish to obtain regular vegetable sambar (376 g). Total cooking time for the Carrot and bottle gourd sambar was 40 minutes approximately.

Preparation of Vegetable Sambar using B2E cooking process: The onions used in this dish were peeled, sliced and spiked with known amounts of vitamins (2.5 ng of Vitamin B12, 5 mg of VitaminD3, 50 mg of Vitamin E and 15 mg of Vitamin A). The spiked batch of onions went through the standard cooking and dehydration process used for all the vegetables in B2E process. The B2E version of the vegetable sambar was prepared as per the following steps using precooked dehydrated and oil free vegetables and precooked bases equivalent to their corresponding weights used in the regular cooking process described above. The spice extracts were used either at quantities equivalent or less than equivalent quantities compared to their corresponding raw spices quantities used in the regular process disclosed above. a) Pre-cooked dehydrated and oil free Bottle gourd (1.85 g) and Carrot (4.7 g), were taken in a suitable container; b) Similarly, chopped dehydrated forms of toor dal (45 g), onions (2 g), shallots (4.4 g) tomatoes (1.9 g), garlic (1.5 g) and curry leaves (0.1 g) were added to the container; c) The components selected from steps (a) and (b) were mixed to obtain the blend; d) Boiling water (350 g) was added to the container having the blend from step (c); e) Then 1 drop of cumin seed extracts, 1 drop mustard seeds extract, 2 drops of red chilli extract, I drop of fenugreek extract and 1 drop of diluted turmeric extract (one-part turmeric extract is diluted with three parts edible oil), 5 drops of sambar powder extract were added to the rehydrating vegetables; f) The contents were mixed well and covered with tight lid for 5 minutes to rehydrate, g) Opened lid and added salt (3 g) refined oil (5 g), ghee (5 g) and tamarind paste (5 g) and the contents were mixed gently to obtain B2E version of the Bottle Gourd and Carrot sambar (459 g).

The samples of the conventional and B2E versions of Bottle Gourd and Carrot sambar were evaluated for nutritional parameters such as protein, dietary fiber, carbohydrate, energy, fat and vitamins. The observed nutrient values were converted into nutrient values in total weight of the recipe samples prepared and the results are summarized in Table 14.

TABLE 14
Nutritional data for conventional and B2E
versions of Bottle Gourd and Carrot Sambar.

| | | | | % Change in B2E |
|---|---|---|---|---|
| | | | | version |
| | | | | compared to |
| Nutritional | Unit of | Conventionally | | conventional |
| Parameter | nutrition | cooked | B2E | version |
| Protein | g | 12.14 | 14.09 | 16.03 |
| Dietary Fiber | g | 12.67 | 17.07 | 34.75 |
| Energy | kcal | 342.65 | 217.61 | −36.49 |
| Total | g | 36.55 | 42.46 | 16.17 |
| Carbohydrates | | | | |
| Total Fat | g | 19.25 | 2.85 | −85.22 |
| Vitamin E | mg | 24.44 | 29.65 | 21.32 |
| Vitamin B12 | μg | 1301.71 | 2644.30 | 103.14 |
| Vitamin A | IU | 0.49 | 0.56 | 16.40 |
| Vitamin D3 | μg | 436.12 | 687.08 | 57.54 |

### Example 21

### Ridge Gourd Curry

Preparation of Ridge gourd curry using a regular cooking process: Ridge gourd and onions were cleaned, peeled, and cut into small pieces and kept aside. The onions were then spiked with known amounts of vitamins (2.5 mg of Vitamin B12, 5 mg of Vitamin D3, 50 mg of Vitamin E and 15 mg of Vitamin A). Tomatoes were cleaned and cut into small pieces. Sunflower oil (11.5 g) was dispensed into a pressure cooker pan and heated. Diced garlic (8 g), fresh curry leaves (1.66 g) and onions (72.5 g) were added sequentially to the pan and the mixture was sautéed until onions were translucent. Then, Ridge gourd pieces (350 g) and chopped tomato (91.5 g) were added to the pan followed by turmeric powder (0.62 g), red chilli powder (3.5 g), cumin powder (1.5 g) water (50 g) and salt (5 g). The contents were mixed well and the cooker lid was closed along with the pressure regulator. The contents were allowed to cook on medium flame for two whistles and the heat is then turned off. The cooker is then rested until the pressure got released. The contents were further cooked on an open pan for 5 more minutes to achieve desired consistency to obtain conventional Ridge Gourd curry. Total cooking time for the Ridge Gourd curry was 35 minutes approximately

### Ridge Gourd Curry—B2E Version:

### Preparation of Ridge Gourd Curry Using Blend to Eat(B2E) Cooking Process:

The onions used in this dish were peeled, sliced and spiked with known amounts of vitamins (2.5 mg of Vitamin B12, 5 mg of Vitamin D3, 50 mg of Vitamin E and 15 mg of Vitamin A). The spiked batch of onions went through the standard cooking and dehydration process used for all the vegetables in B2E process. The B2E version of the Ridge Gourd Curry was prepared as per the following steps using precooked, dehydrated and oil free vegetables and precooked bases equivalent to their corresponding weights used in the regular cooking process described above. The spice extracts were used either at equivalent quantity or less than equivalent quantities compared to the raw spices used in the regular process disclosed above. a) Dehydrated ridge gourd cubes (14 g) were taken in a suitable container with lid; b) Similarly, chopped, spiked, cooked and dehydrated onions (9.6 g), chopped dehydrated tomatoes (3.4 g), dehydrated forms of garlic (2.4 g) and curry leaves (0.20 g) were added to the container; c) The components selected from steps (a) and (b) were mixed to obtain the blend; d) Boiling water (390 g) was added to the container having the blend from step (c); e) Then, 3 drops of cumin seed extract, 7 drops red chili extract and 1 drop of diluted turmeric extract (one-part turmeric extract is diluted with three parts edible oil) were added to the rehydrating vegetables; f) The contents were mixed well and covered with tight lid for 5 minutes, g) Open lid and added salt (3 g) and refined oil (5 g), mixed gently and allow the contents to rehydrate for 2 more minutes to obtain B2E version of the Ridge Gourd curry (484 g).

The samples of the conventional and B2E versions of Ridge Gourd curry were evaluated for micronutrients (vitamins). The observed values were converted into micronutrient values in total weight of the recipe samples prepared and the results are summarized in Table 15

TABLE 15
Nutritional data for conventional and
B2E versions of Ridge Gourd curry.

| | | | | % Change in B2E |
|---|---|---|---|---|
| Nutritional | Unit of | Conventionally | | version compared to |
| Parameter | nutrition | cooked | B2E | conventional version |
| Vitamin E | mg | 24.42 | 30.93 | 26.65 |
| Vitamin B12 | μg | 1278.02 | 2427.26 | 89.92 |
| Vitamin A | IU | 0.48 | 0.59 | 21.04 |
| Vitamin D3 | μg | 374.52 | 521.66 | 39.29 |

### Example 22

### Chicken Curry

Preparation of Chicken curry using a regular cooking process: Onions were cleaned, peeled, and cut into small pieces and kept aside. The onions were then spiked with known amounts of vitamins (2.5 mg of Vitamin B12, 5 mg of Vitamin D3, 50 mg of Vitamin E and 15 mg of Vitamin A). Boneless cubes of chicken breast were washed and cut kept aside, Tomatoes were cleaned and cut into small pieces. Sunflower oil (100 g) was dispensed into a thick bottom pan and heated. Ginger paste (15 g), garlic paste (5 g), fresh curry leaves (2 g), chopped onions (200 g) and shallots sliced (50 g) were added sequentially to the pan and the mixture was sautéed until onions were golden brown. Then, chicken pieces (250 g) and chopped tomato (100 g) were added to the pan followed by turmeric powder (1 g), coriander powder (10 g), red chilli powder (10 g), cumin powder (2 g), garam Masala (5 g), and salt (10 g). The contents were mixed well and cooked with the lid closed for 10 mins. The contents were further cooked on an open pan for 5 more minutes to achieve desired consistency. Coriander leaves (5 g), black pepper powder (1 g) and Coconut milk (20 g of coconut milk powder added into 30 g of water) were added and cooked in simmer for 5 more minutes to obtain conventional Chicken curry (817 g). Total cooking time for the Chicken curry was 35 minutes approximately

### Preparation of Chicken Curry Using Blend to Eat (B2E) Cooking Process:

The onions used in this dish were peeled, sliced and spiked with known amounts of vitamins (2.5 mg of Vitamin B12, 5 mg of Vitamin D3, 50 mg of Vitamin E and 15 mg of Vitamin A). The spiked batch of onions went through the standard cooking and dehydration process used for all the vegetables in B2E process. The B2E version of the Chicken Curry was prepared as per the following steps using precooked, dehydrated and oil free chicken and precooked bases equivalent to their corresponding weights used in the regular cooking process described above. The spice extracts were used either at equivalent quantity or less than equivalent quantities compared to those used in the regular process disclosed above. a) Dehydrated chicken cubes (43.1 g) were taken in a suitable container with lid; b) Similarly, cooked dehydrated forms of chopped onions (8 g), sliced shallots (8.2 g), brown onions (20 g), chopped tomatoes (5.6 g), ginger (2.14 g), garlic (1.5 g), curry leaves (0.25 g) and coriander leaves (0.63 g) were added to the container; c) The components selected from steps (a) and (b) were mixed to obtain the blend; d) Boiling water (735 g) along with coconut milk powder(15 g) was added to the container having the blend from step (c); e) Then, 1 drops of cumin seed extract, 4 drops of red chilli, 6 drops of coriander seed extract, I drop of diluted turmeric extract (one-part turmeric extract is diluted with three parts edible oil), 3 drops of garam masala extract and 1 g of black pepper powder were added to the rehydrating meat and vegetables; f) The contents were mixed well and covered with tight lid for 6 minutes, g) Open lid and added salt (10 g) and refined oil (10 g), mixed gently and allow the contents to rehydrate for 2 more minutes to obtain B2E version of the Chicken curry (966 g).

The samples of the conventional and B2E versions of Chicken curry were evaluated for micronutrients (vitamins). The observed values were converted into micronutrient values in total weight of the recipe samples prepared and the results are summarized in Table 16.

TABLE 16
Nutritional data for conventional
and B2E versions of Chicken curry

| | | | | % Change |
|---|---|---|---|---|
| | | | | in B2E |
| | | | | version |
| | | | | compared to |
| Nutritional | Unit of | Conventionally | | conventional |
| Parameter | nutrition | cooked version | B2E version | version |
| Vitamin E | mg | 52.45 | 65.11 | 24.13 |
| Vitamin B12 | μg | 1209.16 | 2708.66 | 124.01 |
| Vitamin A | IU | 0.92 | 1.06 | 16.13 |
| Vitamin D3 | μg | 138.56 | 280.62 | 102.52 |

### Example 23

### Okra (Lady Fingers) Pulusu

Preparation of okra Pulusu curry using a regular cooking process: Onions were cleaned, peeled, and cut into small pieces and kept aside. The onions were then spiked with known amounts of vitamins (2.5 mg of Vitamin B12, 5 mg of VitaminD3, 50 mg of Vitamin E and 15 mg of Vitamin A). Lady fingers were washed, dried, cut and kept aside. Tomatoes were cleaned and cut into small pieces. Sunflower oil (40 g) was dispensed into a heavy bottom pan and heated. Lady fingers (100 g) were added and fried for 5 minutes, taken out and kept aside. In the same pan, Fenugreek seeds (2 g), mustard seeds (1 g), curry leaves (3 g) and allowed it to crackle. Then, whole garlic pods (30 g), chopped onions (150 g) and sliced shallots (75 g) were added sequentially to the pan and the mixture was sautéed until onions were translucent. Then chopped tomato (100 g) was added to the pan followed by turmeric powder (1 g), red chilli powder (10 g) coriander powder (20 g), Then, the fried lady fingers were added back to the pan and sautéed well for 5 minutes. Tamarind paste (50 g) and jaggery (15 g) were added along with water (200 g) and brought to simmer and cooked for 5 minutes and then salt (10 g) was added. Then coconut milk (30 g) (15 g of coconut milk powder added with 15 g of water) was added to the contents and was cooked on medium flame for 10 more minutes to achieve the desired consistency and to obtain conventional Okra (Lady finger) pulusu. Total cooking time for the Bindakaya pulusu was 45 minutes approximately.

### Preparation of Okra Pulusu Using Blend to Eat(B2E) Cooking Process:

The onions used in this dish were peeled, sliced and spiked with known amounts of vitamins (2.5 mg of Vitamin 1312, 5 mg of VitaminD3, 50 mg of Vitamin E and 15 mg of Vitamin A). The spiked batch of onions went through the standard cooking and dehydration process used for all the vegetables in B2E process. The B2E version of the Okra (Bindakaya) pulusu was prepared as per the following steps using precooked, dehydrated and oil free lady fingers and precooked bases equivalent to their corresponding weights used in the regular cooking process described above. The spice extracts were used either at equivalent quantity or less than equivalent quantities compared to those used in the regular process disclosed above. a) Dehydrated lady finger pieces (10.3 g) were taken in a suitable container with lid; b) Similarly, dehydrated powdered onions (20 g), dehydrated shallots (12 g), chopped dehydrated tomatoes (3.8 g), dehydrated forms of garlic (4.3 g) and curry leaves (0.35 g) were added to the container followed by tamarind paste (50 g), coconut milk powder (10 g) and jaggery powder (15 g); c) The components selected from steps (a) and (b) were mixed to obtain the blend; d) Boiling water (730 g) was added to the container having the blend from step (c); e) Then, 5 drops of red chilli extract, 8 drops of coriander seed extract, 1 drop of diluted turmeric (one-part turmeric extract is diluted with three parts edible oil) extract were added to the rehydrating vegetables; f) The contents were mixed well and covered with tight lid for 5 minutes, g) The lid was opened and salt (3 g) and refined oil (10 g) were added followed by a gentle mixing. The contents were allowed to rehydrate for 2 more minutes to obtain B2E version of the okra Pulusu.

The samples of the conventional and B2E versions of Okra pulusu were evaluated for micronutrients (vitamins). The observed values were converted into micronutrient values in total weight of the recipe samples prepared and the results are summarized in Table 17.

TABLE 17
Nutritional data for conventional and B2E versions of Okra pulusu.

| | | | | % Change |
|---|---|---|---|---|
| | | | | in B2E |
| | | | | version |
| | | | | compared to |
| Nutritional | Unit of | Conventionally | | conventional |
| Parameter | nutrition | cooked version | B2E version | version |
| Vitamin E | mg | 52.13 | 62.24 | 19.39 |
| Vitamin B12 | μg | 1705.19 | 2404.78 | 41.03 |
| Vitamin A | IU | 1.03 | 1.18 | 13.97 |
| Vitamin D3 | μg | 676.59 | 872.55 | 28.96 |

### Example 24

### Preparation of Carrot Halwa:

Preparation of Carrot Halwa using a regular cooking process: Carrots were washed, grated and spiked with known amounts of vitamins (2.5 mg of Vitamin B12, 5 mg of VitaminD3, 50 mg of Vitamin E and 15 mg of Vitamin A). The grated and spiked carrots (400 g) and diary cream (100 g) were added to a thick bottomed pan. The contents were mixed well and cooked on a medium heat for 20 minutes. Sugar syrup (100 g) (50 g of sugar in 50 g of water) was then added to the pan and continued the cooking for 15 minutes. Ghee (100 g) was heated in a separate pan to fry (10 g) cashew and (10 g) almonds. The fried nuts were added to the above carrot mixture. Cardamom powder (2 g) was finally added to the contents in the pan, mixed the contents well and further cooked on a slow heat for 15 minutes to obtain conventional Carrot Halwa (346 g).

Preparation of Carrot Halwa in blend to eat (B2E) cooking process: Preparation of carrot Halwa sweet B2E food composition: Carrots(400 g) were washed and grated fine and then spiked with known amounts of vitamins (2.5 mg of Vitamin B12, 5 mg of VitaminD3, 50 mg of Vitamin E and 15 mg of Vitamin A). The spiked batch of carrots went through the standard cooking and dehydration process used for all the vegetables in B2E process. The blend to eat carrot halwa sweet food composition was prepared using the following steps, a) The pre-cooked, dehydrated and oil free grated carrot (54 g) was taken in suitable container; b) 60 g of sugar syrup(derived from 30 g of sugar and 30 g of water) and 100 g diary cream were added to the container; c) The contents from steps ‘a’ and ‘b’ were mixed to obtain a blend; d) The blend from step ‘c’ was added with hot water (140 g) and kept aside for 5 minutes with the lid closed; e) The rehydrated blend in step (d) was treated with 8 drops of cardamom extract and ghee (30 g); f) The contents were mixed well to obtain blend to eat carrot halwa sweet food composition; g) The food composition in step ‘f’ was finally garnished with cashew (10 g) and almond halves (10 g). Final weight is 437 g.

The samples of the conventional and B2E versions of Carrot Halwa were evaluated for micronutrients (vitamins). The observed values were converted into micronutrient values in total weight of the recipe samples prepared and the results are summarized in Table 18.

TABLE 18
Nutritional data for Conventional and
B2E versions of Carrot Halwa Sweet.

| | | | | % Change |
|---|---|---|---|---|
| | | | | in B2E |
| | | | | version |
| | | | | compared to |
| Nutritional | Unit of | Conventionally | | conventional |
| Parameter | nutrition | cooked version | B2E version | version |
| Vitamin E | mg | 22.04 | 27.71 | 25.71 |
| Vitamin B12 | μg | 1953.86 | 1997.96 | 2.26 |
| Vitamin A | IU | 0.44 | 0.52 | 18.34 |
| Vitamin D3 | μg | 924.44 | 1020.96 | 10.44 |

### Example 25

Evaluation of sensory parameters for the blend to eat bottle gourd food composition (LFC001) in comparison with the similar bottle gourd curry food composition (LFCO003) obtained from regular cooking process:

The sensory evaluation of the inventive blend to eat bottle gourd food composition (LFC001) disclosed in example 1 was conducted in human volunteers (panellists) in comparison with the similar recipe (LFCO003) prepared using a regular cooking process (Example 6). Both these samples were packed in similar containers and coded to blind the panellists to the investigational products. Ten panellists were recruited to the study and randomly assigned to one of the two study groups A or B with five members in each group. The study was done in two phases. The samples of blend to eat food composition (LFC001) were assigned to group A and the samples from regular cooking (LFCO003) were assigned to group B in the first phase. All the panellists were given standard sensory evaluation form. Sufficient distance and privacy were ensured among the panellists to prevent scoring interference. All of them filled out the prescribed form rating the appearance, aroma/odour, taste and texture using the numerical scores 1 to 9, wherein the score values assigned were, like extremely=9, like very much=8, like moderately=7, like slightly=6, neither like nor dislike=5, dislike slightly=4, dislike moderately=3, dislike very much=2 and dislike extremely=1. After the first phase tasting and scoring were done, the groups were crossed over to receive alternate test food sample. Before the initiation of the second phase, the panellists were asked to consume plain bread and gargle water to cleanse taste palate. In addition, a 30-minute washout period was also given to further prevent the crossover taste. The A group panellists then received the curry sample from regular cooking process and the B group received blend to eat food composition. After the second phase tasting and scoring were completed, the data was compiled and average score for each sensory parameter was calculated. The results are summarized below in table 19.

TABLE 19
Average Sensory Evaluation Scores

| Sensory | Blend to eat food | Similar food sample |
|---|---|---|
| parameter | composition | from regular cooking |
| Appearance | 7.6 | 5.8 |
| Aroma/odour | 8.8 | 5.3 |
| Taste | 8.5 | 6.3 |
| Texture | 7.4 | 5.2 |

### Example 26

Evaluation of the efficacy of a novel blend to eat (B2E) diet (BE22001) in comparison with a similar diet prepared as per conventional process in improving the health and well-being in healthy adults:

Study details: The primary objective of this study is to assess the efficacy of a novel blend to eat diet (BE22001). The secondary objectives include the acceptability of taste profile and safety of BE22001. BE22001 represents the blend to eat food compositions supplemented to the subjects during the 60 days study period.

Twenty healthy eligible male and female subjects were recruited and randomly assigned into either novel blend diet (BE22001) group or conventional diet group. Vital signs (blood pressure, oral temperature, pulse rate and respiratory rate), serum biochemistry, haematology and urinalysis conducted at baseline and at the end of 60 days of study diet consumption. The subjects received either blend to Eat (B2E) diet (BE22001) or conventional diet (three meals and snacks) as per the diet plan and they did not to consume any additional diet other than study diet. One subject dropped out due to noncompliance to study diet because of personal reasons. Subjects who complied to study diet for at least 80% are considered data evaluation. Results: Consumption of novel blend to eat diet (BE22001) for 60 consecutive days resulted in better reduction of bodyweight (2.35 kg) and BMI (0.91 kg/m²) compared to conventional diet. In the conventional diet consumed subjects showed only 0.36 kg and 0.12 kg/m² reductions in bodyweight and BMI respectively. Improvement in muscle strength and physical activity was seen in BE22001 group compared to conventional diet group as shown by Grip Strength and 6MWT studies. The improvement in distance walked in 6 minute was 31 meters in BE22001 group, whereas only 4.5 meters improvement was observed in conventional diet group.

The BE22001 group showed better reduction of systolic blood pressure, Atherogenic Index Plasma (AIP) and Triglyceride Index (TYG) at the end of the study from the base line. These parameters together indicate that consumption of novel diet for 60 days improve cardiovascular health.

Quality of life questionnaire SF-36 (SF-36QOL) was administered to understand general wellbeing and quality of life. SF-36QOL Vitality and general health scores increased by 12.5 and 15 units in BE22001 group; however, this improvement was only 5.5 and 7.5 units in conventional diet group. This increase in SF-36QOL vitality and general health scores indicate improved energy, vigor and general health.

GSRS and constipation scores were decreased in novel diet BE22001 group to a higher magnitude compared to conventional diet group. This outcome suggests that consumption of novel B2E diet resulted in improved digestion and reduced constipation.

AHSP appetite and daily feelings of hunger scores increased by 7.6 and 10 unites in novel diet group (B2E); whereas, reduction of 2.2 and 3.8 units were observed in conventional diet group. This indicates adequate perception of appetite and hunger in the novel diet group.

Together these results indicate that consumption of novel blend to eat (B2E) food compositions (BE22001) in a human study showed a number of health benefits, which includes reduction of body weight, improvement in lipid profiles, improved energy, improved digestion, reduced constipation, reduced appetite and hunger, improved cardiovascular health; improved satiety; and improved quality of life, general health and vitality.

TABLE 20
Changes in Body weight, BMI and other physical parameters

| S. | | Blend to Eat diet (BE22001) | | Conventional diet | |
|---|---|---|---|---|---|
| No | Parameters | Baseline | Day 60 | Baseline | Day 60 |
| 1 | Body weight (kg) | 74.71 ± 6.05 | 72.36 ± 6.28 | 76.31 ± 7.36 | 75.95 ± 7.26 |
| 2 | BMI (kg/m²) | 28.49 ± 0.98 | 27.58 ± 1.04 | 28.11 ± 1.46 | 28.0 ± 1.5 |
| 3 | Grip Strength | 27.76 ± 4.39 | 30.82 ± 4.27 | 27.90 ± 4.94 | 29.06 ± 5.09 |
| 4 | 6MWT (m) | 453.90 ± 41.51 | 484.90 ± 46.46 | 457.40 ± 38.05 | 461.90 ± 37.03 |
| 5 | Systolic BP (mm/hg) | 125.20 ± 9.85 | 121.50 ± 10.01 | 126.20 ± 9.48 | 127.50 ± 7.17 |
| 6 | Diastolic BP | 78.90 ± 2.81 | 78.00 ± 4.22 | 82.20 ± 3.43 | 82.50 ± 4.25 |
| | (mm/hg) | | | | |

TABLE 21
Changes in efficacy parameters TYG index and AIP

| | | Blend to Eat diet | | | |
|---|---|---|---|---|---|
| S. | Param- | (BE22001) | | Conventional diet | |
| No | eters | Baseline | Day 60 | Baseline | Day 60 |
| 1 | TYG | 8.38 ± 0.60 | 8.2 ± 0.42 | 8.5 ± 0.46 | 8.49 ± 0.46 |
| | index | | | | |
| 2 | AIP | 0.29 ± 0.29 | 0.16 ± 0.23 | 0.30 ± 0.23 | 0.33 ± 0.22 |

TABLE 22
Changes in Questionnaire based parameters

| | | Novel Blend to Eat diet | | | |
|---|---|---|---|---|---|
| S. | Param- | (BE22001) | | Conventional diet | |
| No | eters | Baseline | Day 60 | Baseline | Day 60 |
| 1 | SF-36 QOL (Vitality) | 84.00 ± 3.94 | 96.50 ± 4.12 | 85.00 ± 4.08 | 90.50 ± 5.99 |
| 2 | SF-36 QOL (Gen Health) | 80.00 ± 9.13 | 95.00 ± 6.24 | 82.00 ± 9.19 | 89.5 ± 7.25 |
| 3 | GSRS Digestive | 3.58 ± 0.35 | 1.78 ± 0.46 | 3.55 ± 0.37 | 2.35 ± 0.57 |
| 4 | GSRS Constipation | 3.90 ± 0.50 | 2.47 ± 0.57 | 3.94 ± 0.63 | 3.07 ± 0.58 |
| 5 | AHSP-Appetite | 18.00 ± 3.77 | 25.60 ± 4.09 | 18.20 ± 4.16 | 20.40 ± 3.50 |
| 6 | AHSP-Daily feelings of | 23.80 ± 4.94 | 33.80 ± 5.77 | 24.20 ± 3.94 | 28.00 ± 4.32 |
| | Hunger | | | | |

### Example 27

### Preparation of Blend to Eat Home Style Mutton Kheema Masala

Home Style Mutton Kheema Masala was produced using the following process steps. The pre-cooked, dehydrated minced mutton, pre-cooked vegetable base and required spice/herb extracts were prepared/obtained prior to the preparation of the curry. Home Style Mutton Kheema Masala is using the following steps, a) The pre-cooked, dehydrated meat derived from freshly minced raw mutton was taken in a suitable container; b) The precooked vegetable base derived from 300 g onions, which was sautéed and pureed along with 30 g garlic, 50 g of Ginger and 20 g sliced green chillies, was added to the dehydrated meat in step (a); c) The components selected from steps (b) and (c) were mixed well together; d) The blend in step ‘c’ was hydrated with required amount of hot water to obtain rehydrated blend; e) The rehydrated/reconstituted blend in step (d) was treated with required dosage of selected combination of spice/herb extracts equivalent to 1 g cumin, 2 g fennel, 1 g clove, 2 g green cardamom, 2 g cinnamon, 1 g turmeric, 15 g coriander, 5 g red chilli, 2 g black pepper, 5 g fresh coriander leaves in required quantity of vegetable oil; f) Table salt was finally added to the mixture in step (e) as required; g) The contents were mixed well to obtain blend to eat Home Style chicken curry food composition.

Those of ordinary skilled in the art will appreciate that changes could be made to the embodiments described above without departing from the broad inventive concept thereof. It is understood, therefore, that this invention is not limited to the particular embodiments or examples disclosed herein, but is intended to cover modifications within the objectives and scope of the present invention as defined in the specification. The presented examples illustrate the invention, but they should not be considered to limit the scope of the invention in any way.

1. A blend to eat food composition for a quick serving, which comprises a) a first component selected from pre-cooked, dehydrated and oil free vegetable(s), fruits, pulse(s) and fungi or pre-cooked meat(s) or mixtures thereof; b) optionally a second component selected from pre-cooked plant derived base or animal derived base; and c) a third component containing at least one spice/herb/fruit extract derived from spices and/or herbs and/or fruits or mixtures thereof; further containing optionally desired amount of edible oil and/or salt; for obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually.

2. An ingredient kit for blend to eat food composition for a quick serving, which comprises a) a first component selected from pre-cooked, dehydrated and oil free vegetable(s), fruits, pulse(s) and fungi or pre-cooked meat(s) or mixtures thereof; b) optionally a second component selected from pre-cooked plant derived base or animal derived base; and c) a third component containing at least one spice/herb/fruit extract derived from spices and/or herbs and/or fruits or mixtures thereof; further containing optionally desired amount of edible oil and/or salt; for obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually.

3. A blend to eat food composition for a quick serving, which comprises a) a first component selected from pre-cooked, dehydrated and oil free vegetable(s), fruits, pulse(s) and fungi or pre-cooked meat(s) or mixtures thereof; b) optionally a second component selected from pre-cooked plant derived base or animal derived base; c) and a third component containing at least one spice/herb/fruit extract derived from spices and/or herbs and/or fruits or mixtures thereof; further containing optionally desired amount of edible oil and/or salt; for obtaining at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually;
Wherein the said blend to eat food composition is obtained by the steps of, a) selecting a first component from pre-cooked, dehydrated and oil free vegetable(s), pulse(s) and fungi or pre-cooked meat(s) or mixtures thereof; b) optionally selecting a second component from pre-cooked plant derived base or animal derived base or combinations thereof; c) optionally mixing the components selected from steps ‘a’ and ‘b’ to obtain the blend; d) rehydrating the blend in step ‘c’ with sufficient hot water to obtain rehydrated blend; e) adding a selected third component containing at least one extract derived from spices/herbs/fruits to the rehydrated or rehydrating blend in step ‘d’; f) optionally adding desired amount of salt and/or edible oil as per individual taste, texture and health; g) mixing the contents of step ‘f’ to obtain the blend to eat food composition;
Wherein, the pre-cooked vegetable(s) is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, chikoo, guava, pear, papaya or mixtures thereof;
Wherein, the pre-cooked plant derived base contains one or more of vegetables, pulses, lentils, moong dal, toor dal, urad dal, horse gram, fruits, onions, tomatoes, ginger, garlic, nuts, mango, tamarind, sugar syrup, jaggery or mixture thereof; pre-cooked cereals are selected from rice, wheat, sorghum, millet, barley and maize and the like or mixtures there of; coconut grating or milk; and animal derived products are selected from but not limited to milk, yogurt, whey protein, cream, eggs or mixtures thereof; and the pre-cooked animal base is derived from animal origin selected from but not limited to animal meat and bone stock, animal protein, fat or mixtures thereof; and
Wherein, the third component containing at least one spice/herb/fruit powder or extract is derived from the spices/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seeds, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

4. A blend to eat food composition for a quick serving and the process for producing the composition as claimed in claim 3, wherein the spice extract in step (e) can be added during the rehydration in step (d).

5. A process for preparing the blend to eat food compositions with at least one functional benefit selected from improving flavor including taste and aroma, reducing oil content, optionally reducing salt content, promoting healthy weight loss, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually, for quick serving; wherein the food compositions comprise a) a first component selected from pre-cooked, dehydrated and oil free vegetable(s), pulse(s) and fungi or pre-cooked meat(s) or mixtures thereof; b) optionally a second component selected from pre-cooked plant derived base or animal derived base; and c) a third component containing at least one spice/herb/fruit extract derived from spices and/or herbs and/or fruits or mixtures thereof; further containing optionally desired amounts of edible oil and salt;
which comprises the steps of, a) selecting first a component from pre-cooked, dehydrated and oil free vegetable(s), pulse(s) and fungi or pre-cooked meat(s) or mixtures thereof; b) optionally selecting a second component from pre-cooked plant derived base or animal derived base or combinations thereof; c) optionally mixing the components selected from steps ‘a’ and ‘b’ to obtain the blend; d) rehydrating the blend in step ‘c’ with sufficient hot water to obtain rehydrated blend; e) adding a selected third component containing at least one extract derived from spices/herbs/fruits to the rehydrated or rehydrating blend in step ‘d’; f) optionally adding desired amount of salt and/or edible oil as per individual taste, texture and health; g) mixing the contents of step ‘f’ to obtain the blend to eat food composition;
Wherein, the pre-cooked vegetable(s) is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, pineapple, apple, custard apple, chikoo, guava, pear, papaya or mixtures thereof;
Wherein, the pre-cooked plant derived base contains one or more of vegetables, pulses, lentils, moong dal, toor dal, urad dal, horse gram, fruits, onions, tomatoes, ginger, garlic, nuts, mango, tamarind, sugar syrup, jaggery or mixtures thereof; pre-cooked cereals are selected from rice, wheat, sorghum, millet, barley and maize and the like or mixtures there of; coconut grating or milk; and animal derived products selected from but not limited to milk, yogurt, whey protein, cream, eggs or mixtures thereof; and the pre-cooked animal base is derived from animal origin selected from but not limited to animal meat and bone stock, animal protein, fat or mixtures thereof; and
wherein, the third component containing at least one spice/herb/fruit powder or extract derived from the spices/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seed, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

6. A method of obtaining at least one functional benefit selected from improving flavor including taste and aroma, reducing oil content, optionally reducing salt content, reducing number of cooking steps, reducing preparation time, eliminating tempering step, crafting the dish to personalized taste, selecting and optimizing required levels of nutrients such as carbohydrates, proteins, fats, fiber, macro and micro nutrients, individually; wherein the method comprises preparing a blend to eat food composition having such benefits; which consists the steps of; a) selecting first component from pre-cooked, dehydrated and oil free vegetable(s), pulse(s) and fungi or pre-cooked meat(s) or mixtures thereof; b) optionally selecting second component from pre-cooked plant derived base or animal derived base or combinations thereof; c) optionally mixing the components selected from steps ‘a’ and ‘b’ to obtain the blend; d) rehydrating the blend in step ‘c’ with sufficient hot water to obtain rehydrated blend; e) adding a selected third component containing at least one extract derived from spices/herbs/fruits to the rehydrated blend in step ‘d’; f) optionally adding desired amount of salt and/or edible oil as per individual taste, texture and health; g) mixing the contents of step ‘f’ to obtain the blend to eat food composition,
Wherein, the pre-cooked, dehydrated vegetable(s) to obtain such functional benefits may be selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, apple, pineapple, custard apple, chikoo, guava, pear, papaya or mixtures thereof,
Wherein, the pre-cooked plant derived base to obtain such functional benefits may contains one or more of vegetables, pulses, lentils, moong dal, toor dal, urad dal, horse gram, fruits, onions, tomatoes, ginger, garlic, nuts, mango, tamarind, sugar syrup, jaggery or mixtures thereof; pre-cooked cereals are selected from rice, wheat, sorghum, millet, barley and maize and the like or mixtures thereof; coconut grating or milk; and animal derived products selected from but not limited to, milk, yogurt, whey protein, cream, eggs or mixtures thereof; and the pre-cooked animal base is derived from animal origin selected from but not limited to animal meat and bone stock, animal protein, fat or mixtures thereof; and
Wherein, the third component containing at least one spice/herb/fruit powder or extract or essential oils to obtain such functional benefits are derived from the spices/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seed, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind, Thyme, Turmeric rhizome and mixtures thereof.

7. A method of obtaining at least one health benefit selected from improving healthy weight loss, reducing body weight, reducing triglycerides and cholesterol, increasing healthy cholesterol, improving energy, improving digestion, reducing constipation, reducing appetite and hunger, improving satiety, improving cardiovascular health and improving quality of life, improving vigor and improving general health in mammals; wherein the method comprises supplementing the mammals with a blend to eat food composition, which comprises a) a first component selected from pre-cooked, dehydrated and oil free vegetable(s), pulse(s) and fungi or pre-cooked meat(s) or mixtures thereof; b) optionally a second component selected from pre-cooked plant derived base or animal derived base; c) and a third component containing at least one spice/herb/fruit extract derived from spices and/or herbs and/or fruits or mixtures thereof; further containing optionally desired amount of edible oil and/or salt; wherein the process for preparing the blend to eat food composition comprises the steps of; a) selecting first component from pre-cooked, dehydrated and oil free vegetable(s), pulse(s) and fungi or pre-cooked meat(s) or mixtures thereof; b) optionally selecting second component from pre-cooked plant derived base or animal derived base or combinations thereof; c) optionally mixing the components selected from steps ‘a’ and ‘b’ to obtain the blend; d) rehydrating the blend in step ‘c’ with sufficient hot water to obtain rehydrated blend; e) adding a selected third component containing at least one extract derived from spices/herbs/fruits to the rehydrated or rehydrating blend in step ‘d’; f) optionally adding desired amount of salt and/or edible oil as per individual taste, texture and health; g) mixing the contents of step ‘f’ to obtain the blend to eat food composition,
Wherein, the pre-cooked vegetable(s) is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof; and pre-cooked fruits are selected from the group consisting of banana, mango, chikoo, guava, pear, papaya or mixtures thereof,
Wherein, the pre-cooked, plant derived base contains one or more of vegetables, pulses, lentils, moong dal, toor dal, urad dal, horse gram, fruits, onions, tomatoes, ginger, garlic, nuts, mango, tamarind, sugar syrup, jaggery or mixtures thereof; and animal derived products selected from but not limited to milk, yogurt, soya protein isolate, whey protein, cream, eggs or mixtures thereof; pre-cooked cereals are selected from rice, wheat, sorghum, millet, barley and maize and the like or mixtures there of; coconut grating or milk; and the pre-cooked animal base is derived from animal origin selected from but not limited to animal meat and bone stock, animal protein, animal fat or mixtures thereof, and
Wherein, the third component containing at least one spice/herb/fruit powder or extract or essential oils derived from the spice/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dil, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

8. A process for reducing/simplifying the number of steps for the preparation of a blend to eat food composition having at least one functional benefit selected from improving taste, improving flavor, reducing oil content, reducing number of steps, reducing preparation time, avoiding tempering step, crafting the dish to personalized taste; where in the process comprises the steps of; a) selecting first component from pre-cooked, dehydrated and oil free vegetable(s), pulse(s) and fungi or pre-cooked meat(s) or mixtures thereof; b) optionally selecting second component from pre-cooked plant derived base or animal derived base or combinations thereof; c)optionally mixing the components selected from steps ‘a’ and ‘b’ to obtain the blend; d) dehydrating the blend in step ‘c’ with sufficient hot water to obtain rehydrated blend; e) adding a selected third component containing at least one extract derived from spices/herbs/fruits to the rehydrated blend in step ‘d’; f) optionally adding desired amount of salt and/or edible oil as per individual taste, texture and health; g) mixing the contents of step ‘f’ to obtain the blend to eat food composition;
Wherein, the pre-cooked, dehydrated vegetable(s) is/are selected from but not limited to carrot, beans, squash, eggplant, okra, potato, ivy gourd, ridge gourd, snake gourd, beetroot, bell pepper, bitter gourd, zucchini, corn, pumpkin, green chilli, red chilli, moringa leaves/drumstick, mint, lettuce, cabbage, cauliflower, broccoli, brussels sprouts, fennel, coriander leaf, radish, turnip, spinach, zucchini, celery, peas, mushroom, leafy vegetables, soya bean, asparagus, cultured or wild aquatic flora, animal derived products such as paneer, cheese, vegan meat substitutes, textured protein or the mixtures thereof; pre-cooked pulses are selected from but not limited to lentils, moong dal, toor dal, urad dal, horse gram, adzuki, chana, garbanzo beans, kidney beans, lima beans, mung beans, pinto beans and the like; pre-cooked cereals are selected from rice, wheat, sorghum, millet, barley and maize and the like or mixtures there of; coconut grating or milk; and the pre-cooked meat is selected from meat group which comprises chicken, mutton, sea food, cultured or wild aquatic fauna, eggs or mixtures thereof and pre-cooked fruits are selected from the group consisting of banana, mango, chikoo, guava, pear, papaya or mixtures thereof;
Wherein, the pre-cooked plant derived base contains one or more of vegetables, pulses, lentils, moong dal, toor dal, urad dal, horse gram, fruits, onions, tomatoes, ginger, garlic, nuts, mango, tamarind, sugar syrup, jaggery or mixtures thereof; pre-cooked cereals are selected from rice, wheat, sorghum, millet, barley and maize and the like or mixtures there of; coconut grating or milk; and animal derived products selected from but not limited to, milk, yogurt, whey protein, cream, eggs or mixtures thereof; and the pre-cooked animal base is derived from animal origin selected from but not limited to animal meat and bone stock, animal protein, fat or mixtures thereof; and
Wherein, the third component containing at least one spice/herb/fruit powder or extract or essential oil derived from the spice/herbs/fruits selected from but not limited to Amchoor, Asafoetida, Basil leaf, Bay leaf, Capsicum, Caraway seed, Cardamom green, Cardamom black, Cinnamon, Celery seeds, Chives, Clove, Coriander leaf, Coriander seed, Cumin black, Cumin brown, Curry leaf, Dill seeds, Fennel, Fenugreek leaf, Fenugreek seed, Garlic, Ginger, Green chilli, Kapok buds, Mace, Mint leaf, Mustard seed, Nutmeg, Onion, Onion Fried, Oregano, Parsley leaf, Pepper black, Pepper white, Poppy seed, Red chilli dry (Paprika), Rosemary leaf, Shallots, Star anise, Tamarind fruit, Thyme, Turmeric rhizome and mixtures thereof.

9. The blend to eat food compositions for a quick serving as claimed in claim 1, wherein the spices/herb/fruits extracts are obtained by extraction of the pulverized raw material of spices/herb/fruits with at least one solvent with the polarity index (P) in the range of 0.05 to 10.2, which are selected from C1-C5 alcohols selected from ethanol, methanol, n-propanol, isopropyl alcohol; ketones selected from acetone, methyl isobutyl ketone, chlorinated solvents selected from methylene dichloride and chloroform; water and mixtures thereof; C1-C7 hydrocarbons such as hexane; esters like ethyl acetate and the like; and mixtures thereof.

10. The blend to eat food compositions for a quick serving as claimed in claim 1, wherein, the spice/herb/fruit extracts are obtained by steam distillation of pulverized spice/herb/fruit raw material to obtain the essential oil (EO) first; then the raw material residue is extracted either sequentially or selectively with at least one solvent selected from C1-C5 alcohols selected from ethanol, methanol, n-propanol, isopropyl alcohol; ketones selected from acetone, methyl isobutyl ketone, chlorinated solvents selected from methylene dichloride and chloroform; water and mixtures thereof; C1-C7 hydrocarbons such as hexane; esters like ethyl acetate and the like and mixtures thereof to obtain the extracts thereof; or optionally the selected extract(s) or selected extract(s) and the essential oil corresponding to each raw material can be combined in desired ratio to obtain the final extract/oleoresin/combination with required aroma and flavor; in a further variation of the process, the essential oil (EO) and the extract(s) can be obtained from separate lots of the selected spice/herb/fruit raw material and then the EO and extract(s) can be combined at desired ratio to obtain the final extract/oleoresin/combination with required aroma and taste.

11. The blend to eat food compositions for a quick serving as claimed in claim 1, wherein, the third component may be selected from commercially available oleoresins the spice/herb/fruit essential oil, extracts and/or oleoresins or the mixtures thereof diluted in vegetable oil to facilitate dispensing as per the requirement or natural identical flavors and aromas, coloring agents and food additives, taste enhancers can be used along with the spice/herb/fruit extracts.

12. The blend to eat food compositions for a quick serving as claimed in claim 1, wherein the cooked vegetables are dehydrated using one of the drying techniques selected from but not limited to freeze drying, vacuum drying, hot air oven drying, combioven drying, infrared/radiofrequency/microwave drying (with or without vacuum) or combinations thereof; alternately, the stock liquid and vegetables are separated from the cooked vegetables; the vegetables part dehydrated using the drying techniques disclosed above; and the stock liquid part can be dried using freeze dryer or spray drying or vacuum distillation; or it can be first concentrated under vacuum at slightly elevated temperature to partially remove water and then the final dehydration can be done using freeze drying or spray drying to obtain the juice stock powder; and finally, the juice stock powder and dehydrated vegetables can be combined and blended to obtain pre-cooked and dehydrated vegetables.

13. The blend to eat food compositions for a quick serving as claimed in claim 1, wherein the pre-cooked plant derived base is produced from one or more of vegetables, pulses, fruits, onions, tomatoes, ginger, garlic, nuts, mango, tamarind, sugar, jaggery, and animal derived products selected from but not limited to milk, whey protein, cream, eggs or mixtures thereof; and the pre-cooked animal base is derived from animal origin selected from but not limited to animal meat and bone stock, animal protein, fat or mixtures thereof; wherein the said the bases are prepared with or without the use of vegetable oil; the said base can be used in paste form packed in protective packing; alternately, the cooked vegetable base or the animal base can be dehydrated or partially dehydrated using any of the techniques selected from but not limited to freeze drying, spray drying, vacuum drying, hot air oven drying, infrared/radiofrequency/microwave drying (with or without vacuum) or combinations thereof to obtain the pre-cooked vegetable base or pre-cooked animal base in a thick paste or powder form and the said paste, thick paste or powder form can be used to produce the novel blend to eat food compositions.

14. The blend to eat food compositions for a quick serving as claimed in claim 1, wherein, the food item for making the blend to eat food composition can be selected from but not limited to iguru curries, pulusu curries, dal curries, fry curries, dry roast curries, chutneys, soups, lentil soups, vegetable soups, animal derived soups, sweet recipes, and recipes containing rice, which are selected from regional Indian cuisines (South, Central, North, East and West Indian cuisines) and International cuisines.

15. The blend to eat food compositions for a quick serving as claimed in claim 1, wherein the pre-cooked, dehydrated and oil free vegetable(s), pre-cooked and oil free vegetable(s), pre-cooked the plant derived base(s), pre-cooked animal derived base(s), the pre-cooked plant derived bases without dehydration or partial dehydration, pre-cooked animal derived base(s) without dehydration or with partial dehydration can be packed in retort packing for long term storage.
